(19) United States
(12) Patent Application Publication
(10) Pub. No.: US 2025/0136474 A1
(43) Pub. Date: May 1, 2025

(54) A COMPREHENSIVE LIQUID FILTRATION DEVICE, FILTRATION SYSTEM, AND METHOD THEREOF

(71) Applicant: DETOXYFI, INC., Wilmington, DE (US)

(72) Inventors: Rohit N. Karnik, Cambridge, MA (US); Yukiko Oka, Cambridge, MA (US); Rishon Benjamin, Cambridge, MA (US); Dhananjay Goel, New Delhi (IN)

(21) Appl. No.: 18/691,164

(22) PCT Filed: Sep. 9, 2022
(86) PCT No.: PCT/US2022/076211

§ 371 Date: Mar. 12, 2024

Related U.S. Application Data
(60) Provisional application No. 63/243,154, filed on Sep. 12, 2021.
(60) Provisional application No. 63/367,267, filed on Jun. 29, 2022.

(51) Int. Cl. C02F 1/28; C02F 1/00; C02F 101/30

(52) U.S. Cl. CPC C02F 1/283; C02F 1/002; C02F 1/286; C02F 2101/30; C02F 2201/002; C02F 2303/04

(57) ABSTRACT

A low cost, economical filtration system for removing chemical and microbial contaminants from a liquid is disclosed. The filtration system includes a filter having a body made of wood. The body may have a first surface and a second surface, the first or second surface including at least one slot or opening, which may be perpendicular to the direction of the orientation of the wood. The filter may be inscribed into a container or filter holding part to form a seal. In use, a liquid enters the filter on the first side through the at least one slot and may be filtered whilst passing through the wood to the at least one slot on the second surface for collection as a filtrate. A filtration system can comprise one or more containers integrating the wood filter and permit separation of contaminants from the liquid and isolation of purified liquid.

### RELATED APPLICATIONS AND INCORPORATION BY REFERENCE

This application claims priority to U.S. Provisional Application No. 63/243,154, filed Sep. 12, 2021, and U.S. Provisional Application No. 63/367,267, filed Jun. 29, 2022, the entire contents of which are incorporated herein by reference. All publications and articles referenced herein are expressly incorporated by reference herein in their entireties.

### FIELD

The present disclosure relates to a liquid filtration device and more particularly to a water filtration device that comprehensively filters contaminated water, the method by which it filters contaminated water and stores the purified water, and a filtration system incorporating the liquid filtration device.

### BACKGROUND

Almost 3 billion people across the world are stressed for water. This means that either, a) their present access to water is not fit for consumption, or b) they do not have reasonable access to clean water in their surrounding area, or c) they do not have reasonable access to a method by which they can rid their water of impurities, or d) a combination of any of the above. In the US alone, household tap water has generally been perceived to be clean yet over the past decade many parts of the country have faced multiple health crises, the most infamous in recent memory being in Flint, Michigan, where residents drank water contaminated with lead.

Broadly speaking, world over, water consumed by humans is generally contaminated by three primary contaminant types: a) microbial (e.g., virus, bacteria, protozoa), b) chemical (e.g., lead, arsenic, fluoride etc.), and c) physical (e.g., turbidity, particulates, organic matter). These contaminants enter the infrastructure carrying water in a variety of ways and ultimately humans if the water is left untreated before consumption. To that extent different agencies within the US publish rankings that help people understand the quality of water in their homes. However, upgrading infrastructure to meet national benchmarks does not mean that a) the water is safe to drink across the country or that b) people within the US trust the tap water available to them. Over the years, this mistrust and lack of comprehensive protection against both microbial and chemical contaminants has meant that more and more Americans are buying bottled water or filtration devices that help filter the water in real-time. This problem is more acute across the world where it is estimated that over 2 billion people consume water from sources prone to contamination. In India alone, it is estimated that nearly 600 million people could be water stressed.

Many households rely on small-scale water filtration systems and methods, such as reverse osmosis, gravity-driven filters, cloth or mesh filtration, and others rely on either expensive or ineffective filters as a major component of their processes. Oftentimes, the components of these filters comprise many different materials, have complicated structures, rendering recycling or disposal of the components difficult and troublesome. Thus, there is demand for low-cost, simple, but effective filtration systems.

Upgrading the infrastructure requires huge capital investment and faces execution bottlenecks at scale, which can cause delays to the time it takes for an end-user to get clean drinking water. The disclosed systems and methods may provide a solution to the customer to filter water in real time after gaining access to the water and before consuming it. The disclosed systems and methods may offer a means to decentralize the water treatment methods available to users to enable the end-user to be more in control of his/her access to clean drinking water. In particular, the disclosed devices may use a combination of wood from specific types of trees, optionally, together with activated carbon to create an advanced water filter device class, which filters both microbial and chemical contaminants, as well as physical contaminants, from liquids such as water.

### SUMMARY

A filtration system that includes a container and a filter is disclosed. Both the container and the filter may be biodegradable. In some embodiments, the filtration system may include a first container and a second container. The first container may be configured to accept a feed, such as water or other liquid to be filtered through the filter. The second container may be configured to receive the purified liquid from the filter following purification. In some embodiments, the first container may be nested inside the second container so as to provide an integrated and more compact filtration system. In some embodiments, the first container may be an inner container and the second container may be an outer container. The inner container may be nested within the outer container. The inner container may include an outlet connected to the outer container. The outlet may include the filter housed within a filter holding part. In some embodiments, a filtration system and method of purifying water or another liquid using the filtration system are provided by which the filtered water or liquid is captured, safely stored, and able to be safely consumed or used for other purposes requiring initial purification.

In some embodiments, a filter that can filter contaminated water or other liquid at sufficiently high flow rates and a method by which the filter purifies water or the other liquid is disclosed. In some embodiments, the filter is a wooden filter having a feed side in which the water or other liquid to be filtered is introduced. The water or other liquid to be filtered may be transported via capillary action through tracheid tubes of the xylem tissue in wood to a filtrate side of the wooden filter in which the purified water or other liquid exits the tracheid tubes for collection in the second container. In some embodiments, the filter is further modified to comprise a mechanism by which the filter does not become contaminated or degraded and can continue to filter liquid over extended periods of use. In some embodiments, the wood utilized to make the wooden filter is sapwood from a conifer or a ginkgo tree. In some embodiments, the filter is made from the stem or branch of a primitive angiosperm that lacks xylem vessels. In some embodiments, the filter is made from bamboo. In some embodiments, the filter is made from a section of a bamboo stem that includes a bamboo node.

In some embodiments, the filter comprises at least one slot or opening to increase surface area of the filter and flow rate. In some embodiments, the at least one slot or opening may be machined into the feed side of the filter. In some embodiments, the at least one slot or opening may be machined into the filtrate side of the filter. In some embodiments, the filter comprises a plurality of slots or openings machined into both the feed side and the filtrate side of the filter to increase the filter area and flow rate of the filter.

In some embodiments, at least one slot or opening may be filled with an adsorbent to enhance filtration and removal of biological and chemical contaminants. In some embodiments, the adsorbent may be activated carbon. In some embodiments, the adsorbent may be contained within one or more slots or openings of the filter. In some embodiments, the adsorbent may be contained within a sorbent chamber. The sorbent chamber may be configured such that the water or liquid to be filtered passes through from the first container to the second container through and by way of the chamber containing the adsorbent. In some embodiments, the sorbent chamber may be integrated with the filter. In some embodiments, the sorbent chamber may be removably coupled to the filter. In some embodiments, the sorbent chamber may be removably coupled to the feed side of the filter. In some embodiments, the sorbent chamber may be removably coupled to the filtrate side of the filter.

In some embodiments, a filter comprises a latch mechanism that can be removably coupled to a first container and/or a second container. The first and/or second container may include a means to accept the latch mechanism. The latch mechanism may facilitate replacement of the filter and/or sorbent chamber. In some embodiments, the means to accept the latch mechanism may include a channel, groove, hole, socket, or recess in which the latch mechanism can be inserted and removed.

In some embodiments, a filter is chemically modified or coated to improve resistance to biodegradation. In addition to water, wood primarily comprises cellulose, hemicellulose, and lignin. Cellulose, hemicellulose, and lignin bear hydroxyl groups, which can be acetylated to improve resistance to biodegradation. Thus, in some embodiments, the wood filter can undergo acetylation.

In some embodiments, a filter may be chemically modified or coated to improve its capacity to adsorb chemical, physical, or biological contaminants. In some embodiments, the filter can be partly carbonized or pyrolyzed to improve uptake of contaminants. In some embodiments, the filter may be chemically modified to contain functional groups or sorbent molecules such as cyclodextrin or polymers that can chelate heavy metals.

In some embodiments, a filter may be removed after use and reused to make paper or other products based on wood pulp.

In some embodiments, a filtration system may include a first bottle containing the water or liquid to be filtered and a second bottle for receiving the filtered water or liquid. The filter may be inscribed within a bottle cap having a first end and a second end. The first end of the bottle cap may be configured to be removably attached to a first neck of the first bottle, and a second end of the bottle cap may be configured to be removably attached to a second neck of the second bottle. In some embodiments, the first end and the second end of the bottle cap each may comprise a thread, and the first and second necks each comprise a thread. The respective threads of the first and second ends of the bottle cap and the respective threads of the first and second necks may be configured to rotatably interlock with each other to form a seal.

In some embodiments, the filter may operate utilizing gravity to transport the water or liquid to be filtered through the tracheid tubes of the filter. In some embodiments, filtration may be assisted with addition of pressure. In some embodiments, the filter may be coupled to a flexible bag. The flexible bag may contain the water or liquid to be filtered and the feed side of the filter may be interfaced with the interior of the flexible bag. In some embodiments, the flexible bag comprises a filter holding part to which the filter may be coupled. With respect to the filter holding part, the filter can be embedded within the filter holding part along a circumferential surface, overlaid over the filter holding part, or the filter holding part comprises a structure that houses the filter. In some embodiments, the filter holding part may comprise a cylindrical structure having a recess to house the filter and wherein the cylindrical structure has a flange to facilitate connection to the flexible bag. In operation, a user can apply pressure by squeezing the flexible bag either by hand or via external force to enhance flow of the water or liquid to be filtered through the filter. In some embodiments, the flexible bag may be a pillow, a cushion, or a balloon. In some embodiments, the flexible bag may comprise one or more sheets that can be overlaid and sealed to form a space for holding the water or liquid to be filtered or for the storage of the purified water or liquid.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1A is a perspective view of one example of a filter showing a seal line that may interlock with an opening or an interior of a container to form a continuous, impermeable, watertight seal and the direction of the grain of the wood relative to the direction of the slots. Slots or openings on the feed side of the filter are shown. The dotted lines beneath the slots represent pathways for liquid to be filtered to flow through before flowing into the tracheid tubes. Slots or openings on the filtrate side are not shown for clarity.

FIG. 1B is a cross sectional view of the filter shown in FIG. 1A in accordance with some embodiments. The filter may have a plurality of slots machined into the filter perpendicular to the tracheid tubes and the grain of the wood on the feed side and the filtrate side of the filter. The arrows represent the flow direction of the filtered liquid through the wood from the feed side to the filtrate side.

FIG. 1C is a side view of the filter illustrated in FIGS. 1A and 1B in accordance with some embodiments.

FIG. 1D is a perspective view of another example of a filter showing the plurality of slots machined into the filter perpendicular to the tracheid tubes and to the direction of the grain of the wood.

FIG. 2 is a cross sectional view of another example of a filter in which the seal is on the top surface of the filter. Liquid may enter the filter from the feed side into the slots indicated by arrows. Liquid may flow through two sections of the wood separated by embedded slots before reaching the filtrate side through the left hand and right hand surfaces or the slots connecting to the filtrate side.

FIG. 3A is a cross sectional view of another example of a filter containing an adsorbent in the plurality of slots on the feed side of the filter. The slots may contain a porous cover to hold the adsorbent in place.

FIG. 3B is a cross sectional view of another example of a filter containing an adsorbent in the plurality of slots on the filtrate side of the filter. The slots may contain a porous cover to hold the adsorbent in place.

FIG. 3C is a cross sectional view of another example of a filter containing an adsorbent in the plurality of slots on both the feed and filtrate sides of the filter.

FIG. 3D is a cross sectional view of another example of a filter containing an adsorbent in a plurality of slots disposed between the slots of the feed side and slots of the filtrate sides of the filter.

FIG. 3E is a cross sectional view of another example of a filter in which the adsorbent is contained in a separate enclosure or container located on the feed side of the filter, which permits the liquid to be filtered to flow through the separate enclosure or container into the plurality of slots in the feed side of the filter.

FIG. 3F is a cross sectional view of another example of a filter in which the adsorbent is contained in a separate enclosure or container located on the filtrate side of the filter, which permits the filtrate to flow through the separate enclosure or container into a receiving container.

FIG. 4A is a cross sectional view of another example of a filter connected to a gasket via a latch mechanism on the filter. The gasket may form a seal with the filter.

FIG. 4B is a cross sectional view of another example of a filter with a single latch mechanism that forms a seal with two gaskets.

FIG. 5 is a perspective view of one example of a filtration system utilizing a plurality of filters. The arrows around the periphery of the rim of the container indicate the fitting of a funnel into the opening of the container, which may form a seal with the container. The arrows crossing the funnel indicate the direction of flow through the wood into the container for collection. The funnel may be made of the same or different wood as the filter and the funnel may either serve as the filter or may be configured to receive a filter as an insert.

FIG. 6A is a perspective view of a tree trunk that can serve as a source of the wood for the filter. The various types of wood present in the tree trunk are shown, in particular sapwood, which is cut parallel to the axis of the trunk for machining and shaping into a filter.

FIG. 6B is a perspective view of a rectangular prism into which a piece of wood can be shaped.

FIG. 6C shows an end, top, and side view of one embodiment of the filter configured as a rectangular prism. The slots drawn with solid lines in the top view represent slots on the same plane as the shown top view and the slots drawn with dotted lines in the top and side views represent slots behind the plane of the respective views.

FIG. 6D shows an end, top, and side view of another embodiment of the filter as a rectangular prism. The slots drawn with solid lines in the top view represent slots on the same plane as the shown top view and the slots drawn with dotted lines in the top and side views represent slots behind the plane of the respective views.

FIG. 7A shows one example of a filtration device comprising a container for receiving the liquid to be filtered and a container for collecting the filtered liquid. The container for receiving the liquid to be filtered may contain the filter, which may be connected to a removable chamber containing activated carbon adsorbent via a latch mechanism, forming a seal via a gasket.

FIG. 7B shows another example of the filtration device comprising a container for receiving the liquid to be filtered and a container for collecting the filtered liquid. The container for receiving the liquid to be filtered contains the filter, which is connected to a removable chamber containing activated carbon adsorbent via a latch mechanism, forming a seal via a gasket.

FIG. 7C shows another example of the filtration device comprising a container for receiving the liquid to be filtered and a container for collecting the filtered liquid. The container for receiving the liquid to be filtered contains the filter, which is connected to a removable chamber containing activated carbon adsorbent via a latch mechanism, forming a seal via a gasket.

FIG. 7D shows another example of a filtration device comprising a container for receiving the liquid to be filtered and a container for collecting the filtered liquid. The container for receiving the liquid to be filtered may contain the filter, which is connected to a removable chamber containing activated carbon adsorbent via a latch mechanism, forming a seal via a gasket. The height of the first container in the embodiment of FIGS. 7C&D may be higher than that of the embodiment in FIGS. 7A&B, which increases the water pressure driving the flow of the liquid through the filter when water is poured into the first container and the water level in the second container is low.

FIG. 8 is a perspective view of one example of the filtration system comprising an outer container and an inner container wherein the filter is contained within a filter holding part on the inner container.

FIG. 9A is a perspective view of the filtration system showing an overlay of two overlaid sheets sealed at the edge prior to folding into the shape of the filtration system.

FIG. 9B is a perspective view of the filtration system following the folding of the overlaid sheets of FIG. 9A.

FIG. 10A is a perspective view of a filter holding part of the filtration system in which the filter is attached at its circumferential surface.

FIG. 10B is a perspective view of another example of the filter holding part of the filtration system in which the filter is attached on its filtrate side or feed side.

FIG. 10C is a perspective view of another example of the filter holding part of the filtration system comprising a cylindrical housing, which houses the filter, and wherein the cylindrical housing comprises a flange to facilitate connection of the filter holding part to the filtration system.

FIG. 11A is a view of the filtration system comprising the outer container and the inner container in which the filter holding part is located in the inner container.

FIG. 11B is a view of the filtration system with an elongated part connected with the filter holding part that facilitates replacement of the filter without emptying the feed water in the filtration system.

FIG. 11C is a perspective view of the filtration system in which the sheets are squeezed and compressed to form a tapered, compressed middle portion that houses the filter within the filter holding part.

FIG. 11D is a perspective view of another example of the filtration system in which the bottoms of the sheets are compressed and tapered to accommodate the filter and the filter holding part.

FIG. 11E is a perspective view of another example of the filtration system in which the sheets are pre-cut in a bell shape having a narrow taper to accommodate the filter and the filter holding part.

FIG. 12A is a perspective view of another example of the filtration system having the shape of a pillow or cushion wherein the sheets are sealed around their perimeter and wherein the filter holding part protrudes from a surface of the filtration system.

FIG. 12B is a schematic perspective view of another example of the filtration system in the form of a bottle cap that can be removably attached to a first container and a second container and having a conduit to permit liquid to flow from one end of the bottle cap to the other end in which the filter is recessed within the conduit.

FIG. 13A, shows a method of making a filtration system having a bell-shaped container via cutting commercially-available plastic sheets into multiple bell-shaped parts.

FIG. 13B shows a perspective view of an example of the filtration system having two straps, which can be hung and placed over a container.

FIG. 13C shows a perspective view of another example of the filtration system, wherein a handle hole is cut out from the sheets through which the user can hold or transport the filtration system or from which the filtration system can hang.

FIG. 13D shows a perspective view of another example of the filtration system, wherein the sheets comprise a zipper or a sliding channel to permit opening and closing of the filtration system.

FIG. 13E shows a perspective view of another example of the filtration system comprising one or more straps, which can be single size or adjustable.

FIG. 13F shows a perspective view of another example of the filtration system comprising a belt, which can be single size or adjustable.

FIG. 13G shows a perspective view of another example of the filtration system comprising a belt, which can be single size or adjustable.

FIG. 13H shows a perspective view of another example of the filtration system comprising a strap, which can be single size or adjustable.

FIG. 13I shows a perspective view of another example of the filtration system, wherein a wall of the sheets are tucked to facilitate transporting the filtration system.

FIG. 13J shows a perspective view of another example of the filtration system, wherein the sheets have an elongated bell shape.

FIG. 13K shows a perspective view of another example of the filtration system, wherein the filtration system has convex-shaped walls.

FIG. 13L shows a perspective view of another example of the filtration system, wherein the container that receives the filtered water or liquid comprises a spout for the insertion of a straw.

FIG. 13M shows a perspective view of another example of the filtration system, wherein the container that receives the filtered water or liquid further comprises a spout to permit access to the filtered water or liquid contained and stored in the filtration system.

FIG. 14A shows a perspective view of a biodegradable bag that can be used to create a filtration system, where the bag may be biodegradable.

FIG. 14B shows a perspective view of an example of a filtration system utilizing the biodegradable bag wherein the biodegradable bag is compressed and cinched to form a taper in which a filter holding part may be inserted and sealed to the biodegradable bag.

FIG. 14C shows a perspective view of another example of the filtration system wherein the filter holding part is sealed to the bottom of the biodegradable bag.

FIG. 14D shows a perspective view of another example of the filtration system wherein the biodegradable bag is compressed and cinched to form a taper to which a filter holding part may be sealed.

FIG. 14E shows a perspective view of an example of a filtration system comprising a biodegradable bag wherein the biodegradable bag comprises an outlet connected to tubing and wherein the filter holding part is inserted within the tubing, and where the bag may be biodegradable and a zoomed in perspective view of a hose clamp connection at the outlet.

FIG. 14F shows a perspective view of another example of the filtration system wherein the tubing comprises needle protrusions that can puncture the biodegradable bag at the outlet.

FIG. 14F-1 is a cross section of the filtration system of FIG. 14F taken along line 825 showing the tubing having needle protrusions that penetrate the filtration system at the outlet.

FIG. 14G shows a perspective view of another example of a filtration system wherein tubing can be integrated with a biodegradable bag to form a single contiguous piece.

FIG. 14H shows a perspective view of another example of the filtration system, wherein the tubing is integrated with the biodegradable bag at one end wherein the tubing extends into a separate container.

FIG. 14I shows a perspective view of another example of the filtration system, wherein the biodegradable bag has an elongated shape.

FIG. 14J shows a perspective view of another example of the filtration system, wherein the biodegradable bag has a wide, oblong shape.

FIG. 14K shows a perspective view of another example of a filtration system having the shape of a cushion or pillow.

FIG. 14L shows a perspective view of another example of a filtration system constructed from, or in the shape of, a tree-watering bag such as Treegator®.

FIG. 14M shows a side view of the filtration system of FIG. 14L.

FIG. 15A shows a sheet as used to form a filtration system.

FIG. 15B shows the overlap of sheets of FIG. 15A in forming the filtration system.

FIG. 15C is a side view of the folded sheets.

FIG. 15D is a perspective view of the sheets in which the corners have been sealed.

FIG. 15E is a side view showing sealed ridges.

FIG. 15F is a perspective view of the sheets in which the sides have been sealed and including a spout.

FIG. 15G is a side view of the sealed sheets.

FIG. 15H is a perspective view of a sheet used to form a container for filtered or unfiltered water.

FIG. 15I is a perspective view of another sheet used to form a container for filtered or unfiltered water.

FIG. 15J shows a perspective view of an example of a filtration system in which the filter holding part is located at a tapered end of the container for unfiltered water.

FIG. 15K is a side view of the filtration system of FIG. 15J.

FIG. 15L is a perspective view of an example of the filtration system in which the container for unfiltered water can be attached to the container for filtered water, having a spout for accessing the filtered water.

FIG. 15M, shows a perspective view of an example of a filtration system in which the filter holding part is located within a container for filtered water.

FIG. 15N is a perspective view of an example of the filtration system in which the container for unfiltered water includes a handle to facilitate transport of the container and wherein the container for unfiltered water has a tapered end that can be connected to the filter holding part to effect filtration of unfiltered water within the container.

FIG. 15O shows a perspective view of an example of a sheet used to form a container for filtered or unfiltered water for the filtration system shown in FIG. 15S.

FIG. 15P shows a perspective view of an example of a sheet used to form a container for filtered or unfiltered water for the filtration system shown in FIG. 15S.

FIG. 15Q shows a perspective view of an example of the filtration system in FIG. 15S in which the filter holding part is located in the container for filtered water and the container for feed water can be inserted into the container for filtered water.

FIG. 15R shows a side view of an example of the filtration system in which the filter holding part is located in the container for filtered water.

FIG. 15S shows a perspective view of an example of the filtration system in use in which unfiltered water is fed into a first container that can be inserted into a second container, wherein the water flows through filter holding part of a second container and the filter into the second container, and wherein filtered water can be accessed via a spout.

FIG. 15T shows a side view of an example of the filtration system in use in which unfiltered water is fed into a first container, wherein the water flows through filter holding part into a second container, and wherein filtered water can be accessed via the spout.

FIG. 15U shows a perspective view of another example in which an elongated sheet having one or more filter holding parts can be folded into a container to make the filtration system shown in FIG. 15V, wherein the darkened region is a rigid part that serves as a base.

FIG. 15V shows a perspective view of the folded sheet as container having a narrow bottle shape.

FIG. 15W shows a perspective view of another example in which an elongated sheet can be folded into a container of the filtration system to make the filtration system shown in FIG. 15Z, wherein the darkened region is a rigid part that serves as a base.

FIG. 15X shows a perspective view of the folded elongated sheet comprising spout prior to formation of an internal container comprising the one or more filter holding parts to make the filtration system shown in FIG. 15Z.

FIG. 15Y is a side view of the folded elongated sheet of FIG. 15X.

FIG. 15Z shows a perspective view of the filtration system having an internal container comprising one or more filter holding parts.

FIG. 15AA shows a side view of the filtration system of FIG. 15Z.

FIG. 15AB shows a perspective view of another example of a sheet having a filter holding part, wherein the sheet 1281 can be folded and nested within an outer container, wherein a string can be used to cinch or taper the sheet to make the filtration system shown in FIG. 15AC and FIG. 15AD.

FIG. 15AC shows a perspective view of utilizing a string to cinch or taper the sheet and container to form the filtration system prior to cinching or tapering.

FIG. 15AD shows a perspective view of utilizing a string to cinch or taper the sheet and container to form the filtration system after to cinching or tapering.

FIG. 15AE shows a perspective view of another example of a filtration system comprising an inner container nested within an outer container, wherein the inner container has a filter holding part and wherein a handle is provided to carry the filter system.

FIG. 15AF shows a perspective view of another example of a filtration system comprising an inner container nested within an outer container, wherein the inner container has a filter holding part, and wherein a pair of handles is provided to carry the filter system and a straw is provided to access the filtered water.

FIG. 15AG shows a perspective view of another example of a filtration system comprising an inner container nested within an outer container, wherein the inner container has a filter holding part.

FIG. 15AH shows a perspective view of another example of the filtration system having an hourglass shape comprising an inner container connected to an outer container, wherein the inner container has a filter holding part, and wherein a pair of strings or straps is provided for carrying the filtration system like a backpack.

FIG. 15AI shows a perspective view of another example of the filtration system having an hourglass shape comprising an inner container connected to an outer container, wherein the inner container has a filter holding part, and wherein a strings or straps is provided for carrying the filtration system.

FIG. 16A shows a perspective view of sheets, wherein one or more of the sheets includes a filter holding part at one end, wherein the sheets are overlapped with each other and wherein edges of the overlapped sheets can be sealed to form the filtration system shown in FIG. 16C.

FIG. 16B shows a perspective view of overlapped sheets whose edges have been sealed to form a contiguous container, wherein the filtration system shown in FIG. 16C is formed after folding.

FIG. 16C shows a perspective view of an example of a filtration system comprising an inner container having a filter holding part in which the inner container is nested within an outer container, wherein the inner container is configured to receive water or liquid to be filtered.

FIG. 16D shows a perspective view of the filtration system of FIG. 16C in use, containing unfiltered water within the inner container and wherein a volume of the unfiltered water has passed through the into the outer container as filtered water.

FIG. 16E depicts a perspective view of another example of a filtration system wherein the filtration system comprises a first container having an inlet, and an outlet, wherein the outlet comprises a filter holding part. The first container, except for the inlet, is enclosed, nested in, or contained within a second container wherein the second container has a spout to permit access to filtered water or liquid.

FIG. 16F depicts a perspective view of another example of the filtration system wherein the first container is directly connected to the second container.

FIG. 16G depicts a perspective view of another example of the embodiment of the filtration system wherein the first container is directly connected to the second container and wherein the first and second containers have a rectangular shape.

FIG. 16H depicts a perspective view of another example of the embodiment of the filtration system wherein the first container is directly connected to the second container and wherein the first and second containers have a circular shape.

FIG. 16I shows a perspective view of another example of a filtration system, which can be integrated into clothing or worn on a body. The filtration system comprises a first container comprising a filter holding part wherein the first container is nested inside of a second container.

FIG. 16J depicts a perspective view of another example of filtration system of FIG. 16I mounted onto an animal.

FIG. 17A shows a perspective view of an example of a filtration system comprising a container having a filter holding part comprising a hole housing a filter, wherein the filter has an area larger than the hole and wherein the filter is mounted to the filter holding part via a surface of the filter.

FIG. 17B depicts a perspective view of a filter holding part having a hole having an area smaller than that of a filter, wherein the filter is mounted to the filter holding part via sealing a surface of the filter against the hole.

FIG. 17C depicts a perspective view of one example of a filter holding part comprising a zipper attachment, wherein a filter, encircled by zipper teeth, can be sealed to the filter holding part via zipping the zipper.

FIG. 17D shows a perspective view of another example of the filter holding part having screw threads, wherein the filter, encircled by screw threads, can be screwed into the screw threads, sealing the filter to the filter holding part.

FIG. 17E shows a perspective view of another example of the filter holding part wherein the filter can be sealed to the filter holding part via a hose clamp.

FIG. 17F shows a perspective view and top view of another example of the filter holding part, wherein the filter holding part is configured to accept a flange housing the filter, wherein the filter has silicone, soft rubber-like material, or closed-cell foam added on a circumferential surface of the filter to seal the filter to the flange.

FIG. 17G shows a perspective view of another example of the filter holding part wherein the filter can be sealed to the filter holding part via a hose clamp.

FIG. 17H depicts a perspective view of another example of a filter holding part comprising a flange, having a hollow-channel with a step-tapered structure, wherein the step-tapered structure can accept and house filters of different sizes.

FIG. 17I is a cross section of a filter holding part wherein the inner diameter of the hollow channel tapers towards the base of the flange as a step-tapered structure and wherein the filter holding part can accept and house filters of different sizes. The outer diameter of the wall of the flange tapers towards the base.

FIG. 17J is a cross section of a filter holding part wherein the inner diameter of the hollow channel tapers towards the base of the flange and wherein the filter holding part can accept and house filters of different sizes. The outer diameter of the wall of the flange remains uniform.

FIG. 17K depicts a perspective view of the filter holding part shown in FIG. 17J (base of flange not shown).

FIG. 18A depicts the shape of the hollow channel comprising three layers in depth.

FIG. 18B depicts the shape of the hollow channel comprising three layers in depth.

FIG. 18C shows a mold for casting the insert wherein the insert comprises the hollow channel.

FIG. 18D shows the mold filled with the casting material.

FIG. 18E shows opening and removal of the mold from the insert.

FIG. 18F shows the insert following casting.

FIG. 18G shows another example of the insert wherein the mold can be lifted out from the formed insert.

FIG. 18H shows an example of casting the flange comprising the hollow channel.

FIG. 18I shows a cross section of the insert having the hollow channel in which the filter is housed.

FIG. 18J shows a cross section of the insert housing the filter, wherein the insert has been inserted into a filter holding part.

FIG. 18K shows an example of a filter holding part having the form of a bottle cap insert, the bottle cap insert comprising a body that threads or attaches onto a bottle mouth, wherein the body houses the filter on its inside, a lid that threads or attaches onto the body and seals the filter holding part in place, wherein the lid has an opening that can serve as an inlet for the feed water or an outlet for the filtered water.

FIG. 18L shows the side view of the assembly shown in FIG. 18K.

FIG. 19A shows exploded views of a filter holding part described in the referenced publication by Ramchander et al., comprising a body, a filter, a lid that attaches to the body and seals the filter in place, and one or more gaskets, wherein the lid has an opening that can serve as an inlet for the feed water or an outlet for the filtered water.

FIG. 19B shows a perspective view of the filter holding part whose inlet is connected to a funnel to facilitate reception of a feed of water or liquid for filtration.

FIG. 19C shows a perspective view of the filter holding part whose inlet is connected to a bag to facilitate reception of a feed of water or liquid for filtration.

FIG. 19D shows exploded views of the filter holding part.

FIG. 19E shows a perspective view of an example of the filter holding part whose inlet is connected to a first container and wherein the body is attached to a second container.

FIG. 19F shows a perspective view of an example of the filter holding part whose inlet is connected to a funnel and wherein the body is attached to a container.

FIG. 19G shows a perspective view of an example of the filter holding part whose inlet is connected via tubing to a first bag and wherein the body is connected to a second bag.

FIG. 19H shows a perspective view of an example of the filter holding part whose inlet is connected via tubing to the bag and wherein the body is connected to a rigid container.

FIG. 19I shows a perspective view of another example of the filter holding part whose connecting means include threaded bottle caps such that the filter holding part is configured to fit a specific bottle thread.

FIG. 19J shows a perspective view of another example of the filter holding part whose connecting means include threads such that the filter holding part is configured to fit a specific bottle thread.

FIG. 19K shows an exploded view of an example of the filter holding part comprising a lid having an inlet wherein the lid attaches to a body configured to attach to a bottle or other container via threads.

FIG. 19L shows a perspective view of an example of the body comprising threads and the plate having the bottom hole.

FIG. 19M shows a cross section of an example of the filter holding part in the form of a bottle cap.

FIG. 19N depicts a cross section of another example of a filter holding part, which is used to connect a first bottle containing unfiltered water or liquid to a second bottle, which stores filtered water or liquid, wherein a means is provided to allow air from the filtered water container to escape to the atmosphere and another means is provided for air from the atmosphere to enter into the feed water container.

FIG. 20A is a graph showing the results of the removal of biological contaminants in tested filters (ginkgo, 4-cm diameter, 0.375-inch thickness, no pre-filtration) when operated under 1.2-m gravity head with general test water containing E. coli (≥10⁶ CFU/mL) and MS-2 phage (≥10⁵ PFU/mL) dosed simultaneously, or rotavirus (≥10⁵ PFU/mL), following a procedure reported in the referenced publication by Ramchander et al. Rejection was measured at the start of filter operation and when permeance dropped to 75, 50, and 25% of initial permeance in which different symbols represent different filters.

FIG. 20B is a table that provides the World Health Organization (WHO) scheme for classification of household water treatment technologies, reported in the referenced publication by Ramchander et al.

FIG. 20C is a graph showing the results from experiments measuring the level of coliform bacteria and specifically fecal coliform in a feed from natural spring water (Kith village, Uttarakhand, India) in which the feed was filtered utilizing a filter made from eastern white pine (1 cm diameter, 0.25 inch thickness) and operated under 1 m gravity head, reported in the referenced publication by Ramchander et al.

FIG. 20D is a graph showing the results from experiments measuring the level of coliform bacteria and specifically fecal coliform in a feed from natural spring water (Kith village, Uttarakhand, India) in which the feed was filtered utilizing a filter made from gingko (1 cm diameter, 0.25 inch thickness) and operated under 1 m gravity head, following a procedure in the referenced publication by Ramchander et al.

### DETAILED DESCRIPTION

The filtration systems described herein may provide a consumer with access to clean drinking water through a low-cost wood filter that provides a good flow rate through the filter by which microbial and chemical contaminants can be removed during the filtration process. For example, in some embodiments, the flow rate can range from 0.5 L/h to 30 L/h. In some embodiments, the flow rate of water through the filter may range from 1 L/h to 10 L/h.

Recently, gravity-driven wood filters based on plant xylem were found to be able to effectively remove bacteria, rotavirus, and turbidity from natural water samples such as ground water and contaminated tap water. The filter has opened new opportunities for low-cost, eco-friendly, portable water filtration technology, where naturally-occurring membrane in the plant xylem can remove pathogens that can cause water-borne diseases.

Sapwood comprises the outer layers of wood that conduct sap, in contrast to heartwood, which comprises the inner layer of wood that is filled with lignin and does not conduct sap. In trees, the sapwood conducts sap from the roots to the leaves. Tree species such as maple, ash, hickory, hackberry, beech, and pine generally have thick sapwood layers whereas other tree species such as chestnut, black locust, mulberry, osage-orange, and sassafras have very thin sapwood layers.

Sapwood is a byproduct of the timber industry and is thus economical, affordable, and readily available. Sapwood has been used for making cutlery or utensils for centuries and is widely accepted as a safe, eco-friendly household material.

The sapwood of conifers and ginkgo is well-known to function as a water filter. Sapwood comprises xylem tissue, which, in turn, comprises tubes called tracheids that are oriented longitudinally along the length of trunks or branches of the plant. Water flows much more easily in the direction of the tracheid tubes than in a direction perpendicular to the tracheid tubes. Slices of sapwood, cut transversely with thickness on the order of, or greater than the length of the tracheids acts as a water filter that effectively removes microbiological contaminants (Ramchander, K., Hegde, M., Antony, A. P., Wang, L., Leith, K., Smith, A., & Karnik, R. (2021)). Engineering and characterization of gymnosperm sapwood toward enabling the design of water filtration devices. Nature Communications, 12(1), 1-17). The wood can remove bacterial pathogens, water-borne viruses, and protozoa, which are the causes of diarrheal diseases, from natural water sources such as ground water, or city tap water.

With or without combination with existing water treatment technologies such as chlorination, ion exchange, activated carbon, ceramics or cloths, the present filter presents itself as an extremely low-cost, lightweight, efficient filtration system. However, despite of the benefits realized from using the filter, there still needs more manufacturing-friendly, user-friendly and more carbon-neutral systems for the filtration system while the cost of the whole system stays affordable especially to those who are under-privileged and whose lives are affected by water-borne diseases.

A filter should provide both an adequate flow rate such that a particular volume of filtrate can be obtained in a short amount of time and an effective filtration of the liquid such that the contaminants and impurities can be adequately removed. The permeance of xylem-based filters (defined as flow rate per unit area per unit pressure difference) can drop by a factor of ˜100 upon drying, which limits their usability in dry state. In contrast, wet filters have improved permeance, but limited shelf life due to increased risk for degradation.

The filters must be able to process at least 8 L of water daily (volumetric capacity) to satisfy daily drinking water requirements, have a flow rate of at least 1 L/h, and effectively remove contaminants (satisfying at least 2 of: i) at least 2 log reduction of bacteria; ii) at least 2 log reduction of protozoa; and iii) at least 3 log reduction of viruses to satisfy the World Health Organization's classification for targeted protection with respect to household water treatment). The present filtration system provides a high flow rate (about 0.5 L/h to 30 L/h) to permit more volume to flow through the filter, satisfies the requirements for volumetric capacity (8 L to 100 L) and provides excellent removal of microbes and pathogens commonly found in drinking water (in some embodiments, at least 3 log reduction of E. Coli, MS-2 phage, and rotavirus).

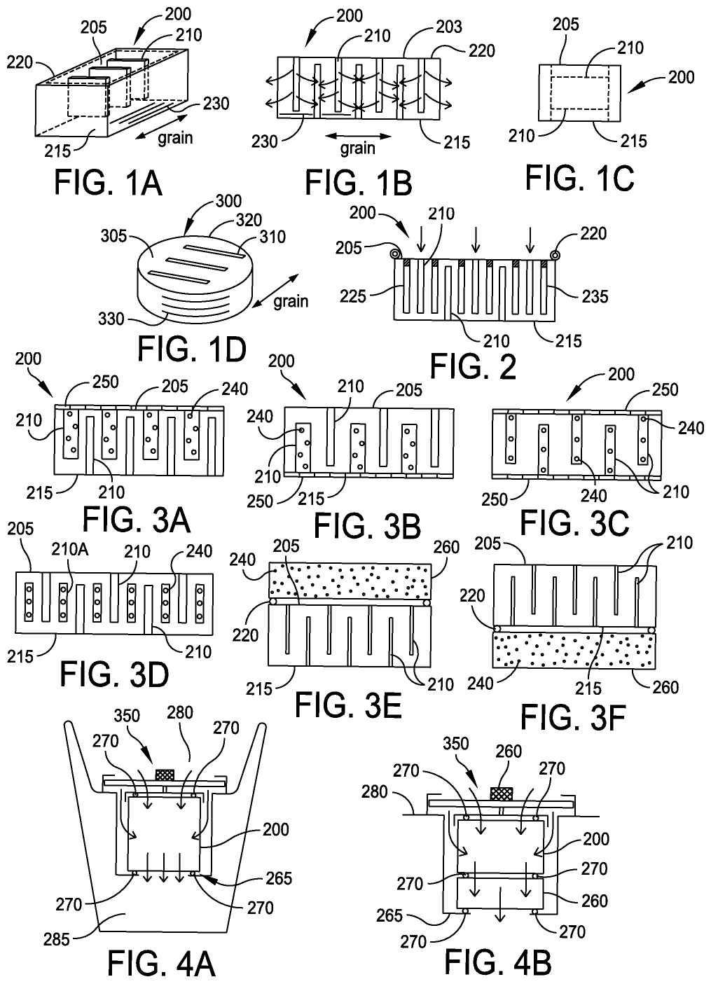

The inventors realized that providing sufficiently high flow rate requires a means to increase the filter area, which is provided by cutting or machining a plurality of slots or openings into a piece of wood as shown in FIGS. 1A-D. While linear slots are shown in FIGS. 1A-D, it should be understood that the slots may take other forms (e.g., curvilinear) or other types of openings (e.g., holes) may be provided.

An exemplary filter 200 is shown in FIG. 1A having the shape of a rectangular prism. The filter 200 has a plurality of slots or openings 210 machined into a first surface 205 and a second surface 215, wherein the slots or openings 210 are oriented perpendicular to the grain of the wood 230 (i.e., perpendicular to the length of the tracheid tubes). When in use, at least one continuous seal is formed along line 220 between the filter 200 and a container (not shown). FIGS. 1B and 1C are cross sections of the filter 200 of FIG. 1A and show the plurality of slots or openings 210 that machined into the first surface 205 and the second surface 215. The arrows in FIG. 1B indicate the direction of flow of water or the liquid to be filtered as it flows through the filter 200.

Another embodiment of the filter 300 is shown in FIG. 1D, which has a circular shape. The filter 300 has a plurality of slots or openings 310 machined into a first surface 305 and a second surface (not shown), wherein the slots or openings 310 are oriented perpendicular to the grain of the wood 330. When in use, at least one continuous seal is formed along line 320 between the filter 300 and a container (not shown).

In some embodiments, the slots are made perpendicular to the direction of the tracheid tubes (tracheid tubes are oriented in the direction of the wood's grain), with some slots connecting to a first surface of the piece of wood and the remaining slots connecting to a second surface located on an opposite side of the piece of wood, where the two surfaces are oriented parallel to the direction of the tracheid tubes. Water can flow from one slot to another through the wood between the slots that functions as a water filtration pathway. The piece of wood can thus function as a filter with multiple water filtration pathways and a greatly increased filter area and flow rate, compared to a solid slice of wood (e.g., a slice of wood that does not include multiple slots or openings).

A filter is provided for the filtration and removal of chemical or microbial contaminants or other impurities from a liquid to be filtered. The liquid can be any liquid containing the chemical or microbial contaminants or other impurities. In some embodiments, the liquid to be filtered is water. In some embodiments, air or a gas is filtered instead of a liquid.

The filter may comprise at least one surface. In an embodiment, the filter comprises a first and a second surface. In some embodiments, the first surface may be located on the feed side of the filter in which the water or liquid to be filtered is fed. In some embodiments, the second surface may be a filtrate side through which the filtered liquid flows through for subsequent collection and processing following filtration.

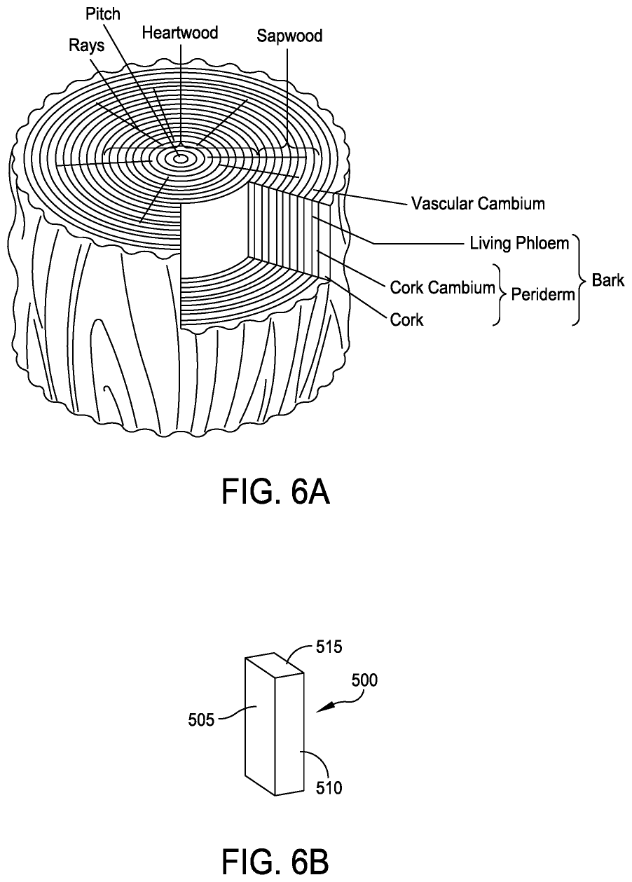

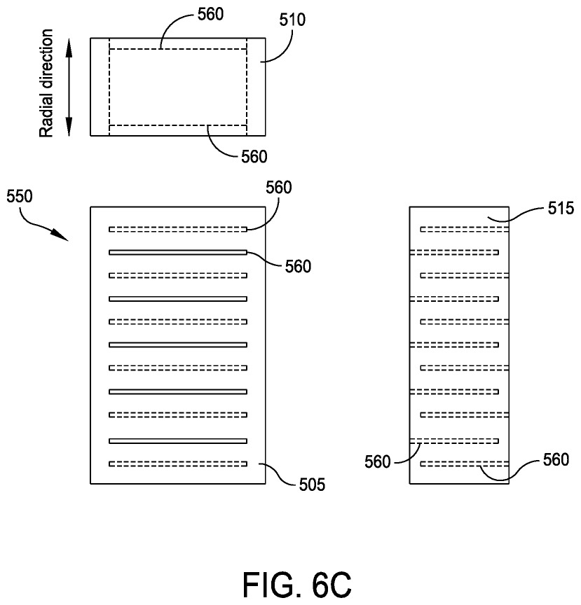

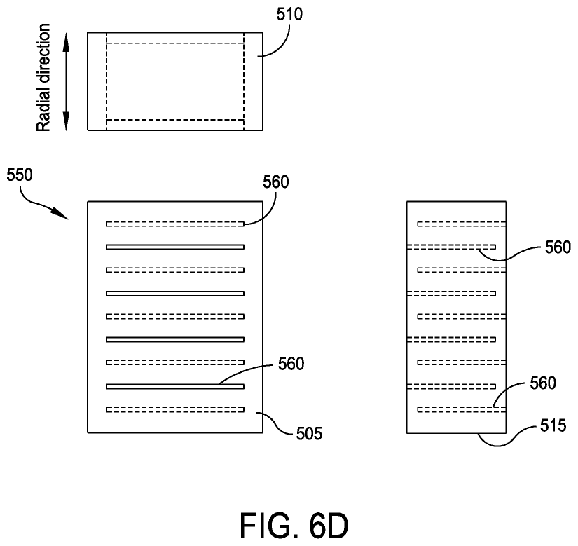

The filter may advantageously be made from wood, which may act as a natural filter in the removal of microbiological or chemical contaminants from the liquid. The wood may also comprise xylem tissue comprising tracheid tubes, which facilitate the flow of water through the wood. In some embodiments, the wood may be a sapwood (FIG. 6A). In some embodiments, the sapwood may be from a conifer. Examples of conifers include trees such as fir, spruce, pine, hemlock, and cedar. Examples of conifer species from which the sapwood can be obtained include but are not limited to Pinus radiata, Pinus strobus, Pinus giabra, Pinus jeffreyi, Pinus ponderosa, Pinus parviflora, Pinus palustris, Pseudotsuga menziesii, Taxus brevifolia, Taxoidum ascendens, Thuja occidentalis, Abies magnifica, Abies concolor, and Larix decidua. In some embodiments, the filter may be made from the sapwood of Pseudotsuga menziesii. In some embodiments, the filter may be made from members of the genus Picea (spruce). In some embodiments, the filter may be made from members of the genus Cedrus (cedar). In some embodiments, the filter may be made from members of the genus Bambusoideae (bamboo). In some embodiments, the sapwood may be from a nonflowering plant. In some embodiments, the filter may be made from the sapwood of ginkgo. In some embodiments, the filter may be made from the sapwood of Ginkgo biloba. In some embodiments, the sapwood may be obtained from primitive angiosperms that lack xylem vessels.

The wood can be of any size. The length, width, and height of the wood may each independently range between about 0.5 cm and about 50 cm, in some examples. In some embodiments, the length, height, and width can be the same or different from each other. In some embodiments, the minimum length, height, or width is about 0.5 cm. In some embodiments, the minimum length, height, or width is about 1 cm. However, it should be understood that other sizes of wood may be used depending upon the applicable application and implementation.

The wood may be manufactured such that the filter can be of any shape. In some embodiments, the filter can be rectangular, circular, oval, or other shapes (FIG. 1D). In some embodiments, the shape of the filter permits the filter to be inserted into a container and to form a seal with the walls of the container. In other words, the shape of the filter permits the filter to be inscribed within the container with respect to the shape of the container.

In reference to the dimensions of the filter with respect to the shape of the filter, the length refers to the longest side of the feed or filtrate side of the filter, the width refers to the shortest side of the feed or filtrate side of the filter, and the height refers to the distance between the feed and filtrate sides of the filter. In some embodiments, the length may be equal to the width (i.e. filters having square or circular feed and filtrate sides) and in some embodiments, the length, width, and height may all be equal (i.e. cube-shaped filter).

In some embodiments, the filter has a round or circular shape having a diameter and a circumference. The filter can be formed to have a diameter between 1 and 20 cm, more specifically, 2 and 15, 3 and 12, 4 and 10, 5 and 9, 5.5 and 8, 6 and 7, or 11 cm.

The filter may comprise at least one slot disposed on a surface of the filter. In some embodiments, the filter comprises a plurality of slots. The slots may be located on the feed side of the filter, the filtrate side of the filter, between both the feed side and the filtrate sides of the filter, or combinations thereof. In some embodiments, the filter may comprise a plurality of slots disposed on both the feed side and the filtrate side of the filter. In another embodiment, the filter further comprises a plurality of slots disposed between the plurality of slots on the feed side and the filtrate side of the filter.

Each of the slots of the plurality of slots may have any length. The length of each of the slots of the plurality of slots may range from between about 1 cm to about 50 cm. The length of each slot in the plurality of slots can each be the same or different. In some embodiments, the length of each slot can be about 1 cm, 2 cm, 3 cm, 4, cm, 5 cm, 6 cm, 7 cm, 8 cm, 9 cm, 10 cm, 15 cm, 20 cm, 25 cm, 30 cm, 35 cm, 40 cm, 45 cm, 50 cm, or combinations thereof. An increase in length of the slot increases the surface area by which the liquid to be filtered can be exposed to and enter the tracheid tubes and, in turn, increases the filtration rate. The length of the slots will be determined by the desired rate of filtration. In some embodiments, the length of each of the slots of the plurality of slots extends across the width of the filter, though this may adversely affect the integrity of the seal formed between the filter and the container depending on the location of the seal.

Each of the slots of the plurality of slots may have any width. The width of each of the slots of the plurality of slots may range from between about 0.1 mm to about 30 mm. The width of each slot in the plurality of slots can each be the same or different. In some embodiments, the width of each slot can be about 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4, mm, 5 mm, 10 mm, 15 mm, 20 mm, 25 mm, 30 mm, or combinations thereof. The size of the slots is designed such that the pressure drop within a slot is small compared to the pressure drop between the feed and filtrate sides. In some embodiments, the size of the slots is designed to accommodate a sorbent inside of the slot. In some embodiments, the width of the slots ranges between about 0.5 mm to about 2 mm.

Each of the slots of the plurality of slots may have any depth. In some embodiments, the depth of each of the slots of the plurality of slots may range from between about 0.1 cm to about 30 cm. The depth of each slot in the plurality of slots can each be the same or different. In some embodiment, the depth of each slot can be about 0.1 cm, 0.2 cm, 0.3 cm, 0.4 cm, 0.5 cm, 0.6 cm, 0.7 cm, 0.8 cm, 0.9 cm, 1 cm, 2 cm, 3 cm, 4, cm, 5 cm, 6 cm, 7 cm, 8 cm, 9 cm, 10 cm, 15 cm, 20 cm, 25 cm, 30 cm, or combinations thereof. The slots may be as deep as the height of the filter permits without puncturing through to the opposite side. In some embodiments, the depth of the plurality of slots range from about 1 cm to about 5 cm. In some embodiments the depth of the plurality of slots is no more than 30%, 40%, 50%, 60%, 70% 80%, 90% or 95% of the height of the filter. In some embodiments, the depth of the slots equals the height of the filter, but the opposite end of the slots is sealed to prevent liquid from passing through the filter without filtration.

Each of the slots of the plurality of slots may be positioned anywhere on the respective surface of the filter. In some embodiments, each slot of the plurality of slots is centered with respect to the shape of the filter and the shape of the feed and filtrate surfaces. In some embodiments, at least one slot of the plurality of slots extends to an edge of the feed side or filtrate side of the filter. Because the integrity of the seal between the filter and the container may be adversely affected by a slot that extends to an edge of the feed side or filtrate side of the filter, a slot that extends to an edge of the feed side or filtrate side of the filter may be located on the side of the filter that does not form the seal with the container. In some embodiments, the filter may not have any edges, such as in a spherical filter, discussed in greater detail below.

The spacing or distance between each slot within the plurality of slots may be of any distance. In some embodiments, the spacing or distance between slots may be of a distance sufficient to both have an effective, fast flow rate and an effective removal of contaminants. If the distance between each slot within the plurality of slots is too large, the flow rate may be too slow. On the other hand, if the distance between each slot within the plurality of slots is too little, there may not be an effective removal of contaminants. A smaller or narrower distance improves the flow rate through the filter whereas a larger spacing improves the removal of contaminants. The spacing or distance between each slot within the plurality of slots can be the same or different. In some embodiments, the spacing or distance between each slot within the plurality of slots is uniform i.e. the slots are evenly spaced apart from each other. In some embodiments, the spacing or distance between each slot within the plurality of slots varies and forms a gradient pattern. In one embodiment, the spacing between each slot within the plurality of slots ranges from about 0.1 mm to about 50 mm. In some embodiments, the width of each slot can be about 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4, mm, 5 mm, 10 mm, 15 mm, 20 mm, 25 mm, 30 mm, 40 mm, 50 mm, or combinations thereof. In some embodiments, the distance between each slot within the plurality of slots is between about 0.5 cm to about 3 cm.

The plurality of slots can be aligned and oriented in any direction on any surface of the filter. The slots, once cut or machined into the piece of wood, may each form an angle from about 0° to about 90° with respect to the direction of the tracheid tubes (i.e., direction of the grain). Each slot can form the same angle as another slot or the slots may form different angles from each other. In some embodiments, the angle of the slots with respect to the orientation of the tracheid tubes can be 0°, 1°, 2°, 3°, 4°, 5°, 6°, 7°, 8°, 9°, 10°, 11°, 12°, 13°, 14°, 15°, 30°, 45°, 60°, 75°, 76°, 77°, 78°, 79°, 80°, 81°, 82°, 83°, 84°, 85°, 86°, 87°, 88°, 89°, or 90°. In some embodiments, the plurality of slots may be parallel with respect to the orientation of the tracheid tubes of the wood, and filtration occurs by flow of water across the walls of the tracheid tubes in a direction perpendicular to the tracheid tubes. In some embodiments, the plurality of slots may be perpendicular with respect to the orientation of the tracheid tubes. Preferably, the slots are perpendicular with respect to the orientation of the tracheid tubes.

The gap between the edges of the slot and the other three surfaces may be small, but should be sufficiently large (e.g., 1 mm to 10 mm) to maintain mechanical integrity of the filter. In some embodiments, the gap is 1 mm, 2 mm, 3 mm, 4, mm, 5 mm, 6 mm, 7 mm, 8 mm, 9 mm, or 10 mm.

In some embodiments, the slots are not parallel to each other and the spacing between the slots is not uniform. In some embodiments, the width, length, or depth of the slots are variable.

In some embodiments, the filter can be in the shape of a sphere bisected by an equator into a first and a second hemisphere, wherein the first hemisphere corresponds to the feed side of the filter and the second hemisphere corresponds to the filtrate side of the filter, or vice versa. The length and the width of the feed side and the filtrate side of the spherical filter correspond to a chord or a meridian of the first or second hemisphere. The height of the spherical filter corresponds to a diameter of the sphere. In some embodiments, the plurality of slots can be inscribed in the first and second hemispheres. In some embodiments of the spherical filter, a seal can form between the filter and the container at the equator of the spherical filter to facilitate operation of the filter. Because the seal forms at the equator of the spherical filter, the length of a slot may extend across an entire chord or meridian, which would not affect the effectiveness of the seal.

In some embodiments, the filter can be in the shape of a smooth object without edges. A seal can form along one continuous curve on the surface of this object that divides the surface of the object into two regions, which defines the feed side and a filtrate side. In some embodiments, a seal forms along more than one continuous curve on the surface of this object that divides the surface of the object into three regions, which defines the feed side, a filtrate side, and a sealing surface that separates the feed side from the filtrate side. Slots are formed on the feed side and/or the filtrate side in this embodiment.

The wood may be cut using various saws, such as circular saw or bandsaw. The wood may be cut using milling and surfaces finished with planning or sanding. Slots may be cut by routers or mills. In some cases, the wood may be machined using a laser cutter or a wood lathe. Other processes used for machining wood may also be used.

The filter can be used to remove microbial contaminants. Examples of microbial contaminants in drinking water include, but are not limited to bacteria, viruses, protozoa, and parasites. The bacteria can be a coliform bacteria, or more specifically, a fecal coliform bacteria. Examples of coliform bacteria include, but are not limited to Escherichia coli, Klebsiella pneumonia, enterobacter, or citrobacter. Other examples of bacteria include, but are not limited to Salmonella typhi, Salmonella paratyphi-A, Shigella dysenteriae, S. Flexneri, S. sonnei, Vibrio cholera, Leptospira sp., Yersinia enterocolitica, Francisella tularensis, or Pseudomonas aeruginosa.

Examples of viral pathogens in drinking water include, but are not limited to enteric viruses, picornaviruses, reoviruses, adenoviruses, bacteriophage, rotavirus, and hepatitis A.

Examples of protozoa in drinking water include, but are not limited to Entamoeba histolytica, Giardia lamblia, and Cryptosporidium.

Examples of parasites in drinking water include, but are not limited to Ascaris lumbricoides, Trichuris trichiura, Ancylostoma duodenale, Necator americanus, and Strongyloides stercoralis.

In some embodiments, the filter can be used to remove chemical contaminants. Examples of chemical contaminants in drinking water include metals, inorganic chemicals, organic chemicals. Examples of chemical contaminants include but are not limited to: lead; arsenic; mercury; manganese; nitrates and nitrites (from fertilizer, livestock manure, and human sewage); atrazine and glyphosate (from agricultural pesticides and herbicides); chlorine; radioactive contaminants such as radon; trichloroethylene and tetrachloroethylene (from degreasers, dry cleaning agents, paint removers, chemical extractors, adhesives, and lubricants); polychlorinated biphenyls; organic contaminants such as tannins and humic acids; and perchlorates.

The disclosed filters may provide a flow rate that permits collection of an adequate volume of water in a shorter timeframe while maintaining an effective filtration and removal of contaminants. The flow rate of a filter can vary depending on the number of slots, the size, spacing, and distance of the slots, the shape of the filter. The flow rate can range from 0.5 L/h to 30 L/h. Preferably, the flow rate of water through the filter ranges from 1 L/h to 10 L/h. Even more preferably the flow rate is about 15 L/h.

The disclosed filter also provides an adequate volumetric capacity, which refers to the volume that may be processed through the filter before the filter must be replaced due to blockage and fouling. The filter must be able to achieve a volumetric capacity of at least 8 L, the daily requirement for volume drinking water. The volumetric capacity of the filter can be about 1 L, 2 L, 5 L, 8 L, 10 L, 15 L, 20 L, 25 L, 30 L, 40 L, 50 L, 60 L, 70 L, 80 L, 90 L, or 100 L.

To use the filter, at least one continuous seal may be formed to separate the feed and filtrate sides, such that water from the feed side must pass through the filter before it reaches the filtrate side. The seal may be formed from a perimeter of the filter inscribing an interior or opening of a container. The seal may circumscribe one of the two surfaces to which the slots are connected. The slots and seal(s) may be configured such that the desired filtration is obtained. For example, in FIG. 2, which shows another embodiment of the filter 200, a leftmost slot or opening 225 and a rightmost slot or opening 235 of the filter may serve as flow pathways instead of slots connecting to the second surface 215, and the seal 220 may form on the first surface 205. Placing the seal 220 on the second surface 215 instead of the first surface 205 may be less ideal in this case, since the leftmost and rightmost slots 225 and 235 of the filter 200 may not be used, and there may be no pressure drop and no flow through the leftmost and rightmost slots 225 and 235. In some embodiments, the leftmost and rightmost slots 225 and 235 of the filter 200 may be coated with an impermeable layer to direct the flow of water or the liquid to be filtered towards the plurality of slots or openings 210 on the second side 215 of the filter.

The filter may be rinsed with water and sterilized or disinfected by chemical means, thermal means, or radiation and used without drying. It may be dried and preserved as previously described (Ramchander, K., Hegde, M., Antony, A. P., Wang, L., Leith, K., Smith, A., & Karnik, R. (2021)). Engineering and characterization of gymnosperm sapwood toward enabling the design of water filtration devices. Nature Communications, 12(1), 1-17). The filter may be packaged individually or otherwise in a packaging that acts as a barrier to moisture and contaminants. The user can open the package prior to use of the filter in a liquid filtration device.

The filter can be used alone or in combination with at least one other filter. Two filters placed in series with each other may improve the effectiveness of the filtration system (Ramchander, K., Hegde, M., Antony, A. P., Wang, L., Leith, K., Smith, A., & Karnik, R. (2021). Engineering and characterization of gymnosperm sapwood toward enabling the design of water filtration devices. Nature Communications, 12(1), 1-17). The filters in series may be stacked on top of each other or may be spaced apart along the filtration path. An arrangement of the plurality of slots 210 as shown in FIG. 2 may be used to realize filtration in series. In such an arrangement, one set of the plurality of slots may connect to the feed side on the first surface 205, a second set of slots may connect to the filtrate side on the second surface 215, and a third set of enclosed slots (not shown), which may not connect to any side, are included such that an enclosed slot may be situated in between a slot or opening on the first surface 205 and a slot from the third set of slots and water flowing from one slots or openings on the first surface 205 to one slots or openings on the second surface passes through a filtration pathway, then through an enclosed slot, and then through another filtration pathway. In some embodiments, the slots in the third set of slots may be created by machining starting from one of the surfaces of the piece of wood, and the entrance to the slot may be sealed using glue or other means. In some embodiments, more than one set of enclosed slots may be present such that there are more than two filtration pathways in series with each other. When the liquid to be filtered flows through two wood filter thicknesses, the flow rate may be approximately halved. For the same volume of wood (i.e. a filter having the same size), the flow rate may be approximately one quarter because half of the wood is used for a subsequent filtration step in which the flow rate is further halved.

The filter may be assembled from a single piece of wood or, if a suitably large piece of wood is not available to make the filter, the filter may be assembled from smaller pieces of wood or other materials. The smaller pieces of wood can be glued together or otherwise held in place in a structure that creates similar pathways of flow as shown in FIG. 1 and FIG. 2. The structure may consist of wood, plastic, silicone, or other materials.

The filter may be modified to improve its performance or to prolong its usable life.

Wood is known to biodegrade over a timescale of days to weeks. The filter may be chemically modified to make it resistant to degradation. In some embodiments, the filter is modified by acetylation or other means to make the filter less susceptible to degradation, such as described in M Rowell, R. (2014). Acetylation of wood—A review. International Journal of Lignocellulosic Products, 1(1), 1-27; Mantanis, G. I. (2017); Chemical modification of wood by acetylation or furfurylation: A review of the present scaled-up technologies. BioResources, 12(2), 4478-4489; Jebrane, M. & Sébe, G. (2007); A novel simple route to wood acetylation by transesterification with vinyl acetate. Wood Research and Technology, 61(2), 143-147), all of which are incorporated by reference herein in their entireties. Acetylation is a method that modifies the hydroxyl groups in the wood and makes the wood less susceptible to enzymatic degradation. The extent of the reaction and the reaction conditions may be controlled to preserve the integrity of the pit membranes in the xylem tissue. Several methods to modify pectin including to enhance its antimicrobial activity and make it resistant to degradation may be employed, since pectin is one of the components of membranes in xylem tissue. Examples of such methods are disclosed in Kumar, M., Tomar, M., Saurabh, V., Mahajan, T., Punia, S., del Mar Contreras, M., . . . & Kennedy, J. F. (2020); Emerging trends in pectin extraction and its anti-microbial functionalization using natural bioactives for application in food packaging. Trends in Food Science & Technology, 105, 223-237; Noreen, A., Akram, J., Rasul, I., Mansha, A., Yaqoob, N., Iqbal, R. & Zia, K. M. (2017); Pectins functionalized biomaterials; a new viable approach for biomedical applications: A review. International journal of biological macromolecules, 101, 254-272; Calce, E., Mignogna, E., Bugatti, V., Galdiero, M., Vittoria, V., & De Luca, S. (2014). Pectin functionalized with natural fatty acids as antimicrobial agent. International Journal of Biological Macromolecules, 68, 28-32), all of which are incorporated by reference herein in their entireties. Similarly, many different ways to modify cellulose and hemicellulose impart resistance to biodegradation or to impart antimicrobial properties may be used, including those described in Kalia, S., Thakur, K., Celli, A., Kiechel, M. A., & Schauer, C. L. (2013); Surface modification of plant fibers using environment friendly methods for their application in polymer composites, textile industry and antimicrobial activities: A review. Journal of Environmental Chemical Engineering, 1(3), 97-112; Dong, C., Ye, Y., Qian, L., Zhao, G., He, B., & Xiao, H. (2014). Antibacterial modification of cellulose fibers by grafting β-cyclodextrin and inclusion with ciprofloxacin. Cellulose, 21(3), 1921-1932; Lobo, F., Franco, A. R., Fernandes, E. M., & Reis, R. L. (2021); An overview of the antimicrobial properties of lignocellulosic materials. Molecules, 26(6), 1749), which are incorporated by reference in their entireties.

In some embodiments, antimicrobial agents may be incorporated into the filter or into the filter package. These agents may serve the dual purpose of protecting the filter against degradation and also enhancing removal of microbiological contaminants in the water. Graft polymerization, such as described in Roy, D., Semsarilar, M., Guthrie, J. T., & Perrier, S. (2009) and Cellulose modification by polymer grafting: a review. Chemical Society Reviews, 38(7), 2046-2064), which are incorporated by reference herein in their entireties, or physical coating methods may be used to functionalize the filter with antimicrobial or degradation-resistant polymers or functional groups. A variety of coatings may be adapted for use in filters, such as those described in Kugel, A., Stafslien, S., & Chisholm, B. J. (2011). Antimicrobial coatings produced by “tethering” biocides to the coating matrix: A comprehensive review. Progress in Organic Coatings, 72(3), 222-252, which is incorporated by reference herein in its entirety. In some embodiments, the filter may be soaked with antimicrobial agents in the form of small molecules, ions, or nanoparticles. For example, colloidal silver may be applied using methods developed for other porous material filters, as described in (Oyanedel-Craver, V. A., & Smith, J. A. (2008) and Sustainable colloidal-silver-impregnated ceramic filter for point-of-use water treatment. Environmental science & technology, 42(3), 927-933, which are incorporated by reference herein in their entireties.

The filter may be modified or coated to enhance removal of contaminants. Many methods have been developed to improve the ability of cellulosic biomass to remove chemical contaminants, which may be applied to the filter. Examples of such methods include those described by Ramrakhiani, L., Ghosh, S., & Majumdar, S. (2016), Surface modification of naturally available biomass for enhancement of heavy metal removal efficiency, upscaling prospects, and management aspects of spent biosorbents: a review. Applied biochemistry and biotechnology, 180(1), 41-78, which is incorporated by reference herein in its entirety. The filter may be partly carbonized or pyrolyzed to improve uptake of contaminants. It may be modified by functional groups or sorbent molecules such as cyclodextrin or polymers that can chelate heavy metals. In some embodiments, the filter may be chemically modified using citric acid. In some embodiments, the filter may be coated using atomic layer deposition to apply a coating of thickness between 1 nm and 10 μm on all surfaces of the filter including the inside of tracheid tubes and pit membranes while retaining the ability to flow liquid through the filter. In some embodiments, the coating is a metal such as silver or copper. In some embodiments, the coating is an oxide such as titania, zirconia, hafnia, or alumina. In some embodiments, the filter may be coated using methods including physical vapor deposition, chemical vapor deposition, adsorption, layer-by-layer deposition, or covalent crosslinking. In some embodiments, the modification or coating of the filter may be done in only part of the filter, which may be helpful where such modification compromises the ability of the filter to remove microbiological contaminants.

The filter may be combined with activated carbon or other adsorbents to provide removal of chemical contaminants. Examples of other adsorbents that may be used in the filter include, but are not limited to chitosan, zeolite, and clay minerals. In some embodiments, bio-sorbents such as yeast may be used. FIGS. 3A-3E show alternative embodiments of the filter 200 containing an adsorbent.

In the embodiment of the filter 200 shown in FIG. 3A, the adsorbent 240 is contained in the plurality of slots or openings 210 on the first surface 205.

In the embodiment of the filter 200 shown in FIG. 3B, the adsorbent 240 is contained in the plurality of slots or openings 210 on the second surface 215.

In the embodiment of the filter 200 shown in FIG. 3C, the adsorbent 240 is contained in the plurality of slots or openings 210 on both the first surface 205 and the second surface 215.

In the embodiment of FIG. 3D, the adsorbent 240 may be contained in a third set of slots or openings 210A situated between the plurality of slots or openings 210 on the first surface 205 and the second surface 215. The width of the slots or openings 210, 210A may be varied to allow different quantities of adsorbent to be contained in the filter 200 and to vary the contact time of the water with the adsorbent 240.

In the embodiment shown in FIG. 3E, the adsorbent 240 may be located on the feed side on the first surface 205 of the filter 200 and contained in an enclosure 260 whose walls permit water to flow through. In the embodiment shown in FIG. 3F, the adsorbent 240 may be located on the filtrate side on the second surface 215 of the filter 200 and contained in an enclosure 260 whose walls permit water to flow through. In some embodiments, the adsorbent 240 may be located on both the first and second surfaces 205 and 215 of the filter 200 and contained in enclosures 260 whose walls permit water to flow through. The size and aspect ratio of the enclosure may be varied to change the amount of adsorbent and contact time of the water with the adsorbent. In some embodiments, the enclosure may be made of wood and may be glued to the filter. In some embodiments, the enclosure may have a gasket that seals against one of the surfaces of the filter.

The adsorbent may be in the form of a powder, porous monolith, or coating on a porous material (including wood). A porous cover or enclosure 250 may be applied to contain the adsorbent 240 (FIG. 3A-C). In some embodiments, the porous cover 250 may consist of paper, thin slices of wood, plastic, silicone, or other material with pores in it that allow flow of water. In some embodiments, the adsorbent may be glued in place.

In some embodiments, multiple adsorbents or antimicrobial agents or coatings may be employed. In some embodiments, the adsorbents or antimicrobial agents or coatings on the feed side and filtrate side are different. In some embodiments, the adsorbents may be tailored to facilitate and enhance filtration of specific contaminants or types of contaminants. In some embodiments, the adsorbents may be tailored to specific types of water to be filtered (e.g. spring water, river water, swamp water, runoff, hard or soft water) or to meet specific needs of users.

In some embodiments, a liquid filtration device 350 includes a replaceable filter. The filtration device 350 may include a receiving container 280 into which the water to be purified may be poured (feed side) and a filtrate container 285 into which the filtrate may be collected. The filtration device 350 may further comprise a mechanism 265 such as that shown in FIGS. 4A and 4B, to house at least one replaceable filter 200. The filtration device 350 may be configured such that water from the feed container 280 passes through the filter 200 to be collected in the filtrate container 285. The filtrate container 285 may have a faucet, spout, outlet, or other mechanism to access or pour the water out (not shown). The feed container 280 may be located higher than the filtrate container 285 to provide a gravitational head to drive the flow of water through the filter. The height of the containers may range from 10 cm to 150 cm. In some embodiments, the height of the containers may be greater than 150 cm. The lateral dimensions of the containers may range between 5 cm and 100 cm. The filter 200 of the filtration device 350 may be modified or combined with an adsorbent as described above. The filtration device 350 may also include a gasket 270 that forms a continuous seal that separates the feed and filtrate sides located on the first and second surfaces 205 and 215, respectively. The gasket 270 may be rectangular, circular, oval, etc. and is preferably contained in a plane. In one embodiment, the filter 200 may be coated with a thin layer of silicone, glue, plastic, or other coating that provides a smooth surface to form a seal with at least one gasket 270. The gasket 270 may be formed of rubber, silicone, or other flexible material that can form a conformal seal against the first surface 205 or second surface 215 of the filter 200. In some embodiments, the gasket 270 can be formed from a hard material such as stainless steel that cuts into the wood to form a seal with the filter 200.

In some embodiments, the gasket 270 may be located at the bottom of the feed container. The mechanism 265 may be provided to enable easy replacement of the filter 200 by the user. As shown in FIGS. 4A and 4B, the mechanism 265 is a latch mechanism that applies a force to push the filter against the gasket 270 using a spring mechanism. In some embodiments, the mechanism can be a screw mechanism.

The filtration device 350 may include one or more enclosures 260 with an adsorbent and/or media such as sand that are located upstream, downstream, or both upstream and downstream of the filter. In the embodiment shown in FIG. 4B, one enclosure 260 is located upstream of the filter 200 and another enclosure 260 is located downstream of the filter 200. The enclosures 260 may be removable. In the case where enclosures 260 are provided on either one or both the upstream and downstream sides of the filter 200, the filter may be sealed with one or more gaskets 270 as shown in FIG. 4B. An upstream enclosure may reduce fouling of the filter. A downstream enclosure may be helpful to remove any organic molecules that may be released by the filter.

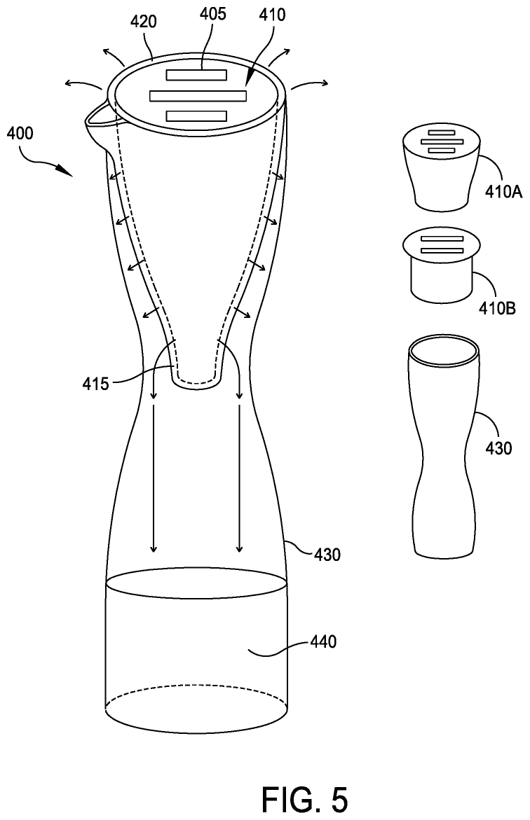

In some embodiments, one or both containers may be made of wood. An exemplary filtration device 400 is shown in FIG. 5, wherein a container 430 can also be made of wood and act as a filter 410. The filtration device 400 including filter 410 can optionally include additional filters 410A and 410B, which can be nested inside filter 410 or stacked with filter 410 such that the filters are in series. A seal 420 is formed between the filter 410 and the container 430. The filter 410 is configured to receive a feed of water or liquid to be filtered at a first surface 405 and the purified water or liquid exits the filter 410 via a second surface 415 into the container 430, wherein the container 430 can be figured to store the filtered water or liquid 440.

FIG. 6A is a cross section of a tree trunk, differentiating the sapwood utilized in the present filters from heartwood located at the center of the trunk.

FIG. 6B shows a rectangular prism having a base 505, an end 510, and a side 515, which will be used to refer to various views of an embodiment of the filter. Although a rectangular prism is shown in FIGS. 6B, it should be understood that the filter may take other forms (e.g., cone, sphere, pyramid, abstract shape) and is not limited thereto.

FIG. 6C is a cross section of a filter 550 as viewed from an end 510, a base 505, and a side 515 wherein the filter has slots or openings 560 machined or carved into opposite bases or surfaces of the filter 550 in which the slots or openings 560 are uniform in length, width, and depth. The slots or openings 560 are centered on the base 505 of the filter 550. However, it should be understood that the length, width, and depth, and placement of the slots or openings 560 may be variable and take on other forms depending upon the applicable application and implementation.

FIG. 6D is a cross section of a filter 550 as viewed from an end 510, a base 505, and a side 515 wherein the filter has slots or openings 560 machined or carved into opposite bases or surfaces of the filter 550 in which the slots or openings 560 are uniform in length, width, and depth. The slots or openings 560 are centered on the base 505 of the filter 550. However, it should be understood that the length, width, and depth, and placement of the slots or openings 560 may be variable and take on other forms depending upon the applicable application and implementation.

In some embodiments, the container that also serves as a filter may be axisymmetric and may be made from a branch or trunk whose axis may be approximately aligned with the axis of the container. In some embodiments, the container may be coated with a lining that includes or is coated with an adsorbent. In some embodiments, the container may include more than one container with a small gap in between the containers. In some embodiments, an adsorbent may be disposed in a gap between the containers, at least one of which functions as a filter.

The filtration device may have additional provisions for pre-filtration, including cloth, sand, or mesh filters.

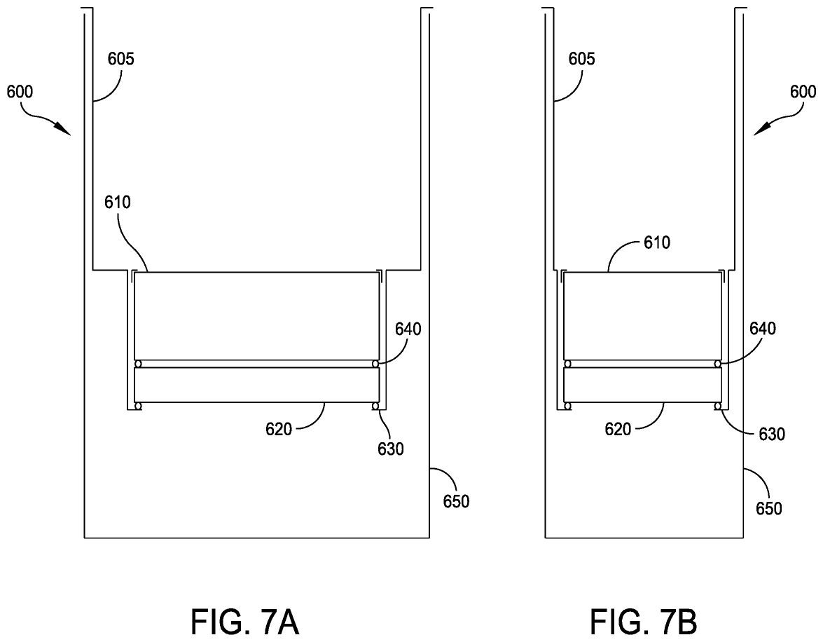

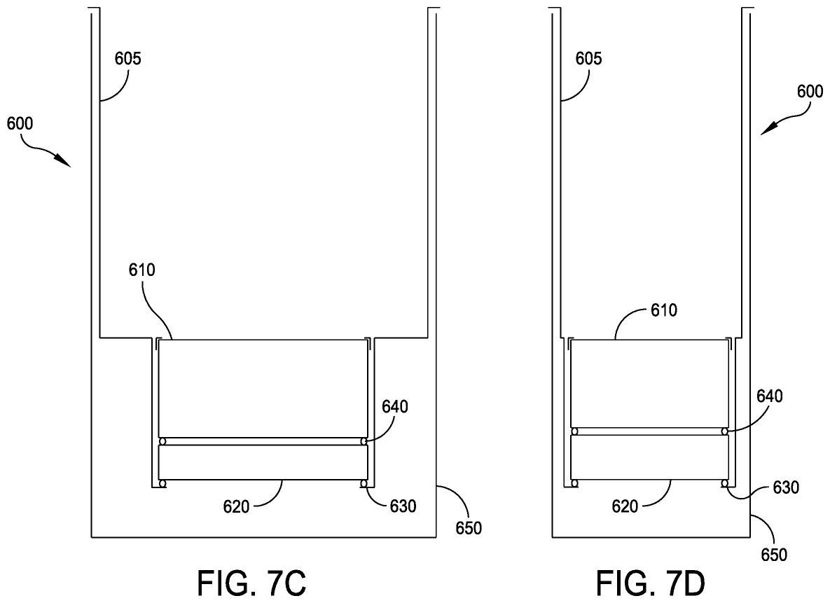

FIG. 7A is a schematic representation of a filtration device 600 comprising a first container 605 for receiving unfiltered liquid, which is nested or stacked on a second container 650 for receiving filtered liquid, and a mechanism 630 configured to be removably attached the first container 605. The mechanism 630 further comprises a filter 610 and a chamber 620 housing an adsorbent. The mechanism 630 can be attached and sealed with the first container 605 via one or more gaskets 640.

FIG. 7B is a schematic representation of a filtration device 600 comprising a first container 605 for receiving unfiltered liquid, which is nested or stacked on a second container 650 for receiving filtered liquid, and a mechanism 630 configured to be removably attached the first container 605. The mechanism 630 further comprises a filter 610 and a chamber 620 housing an adsorbent. The mechanism 630 can be attached and sealed with the first container 605 via one or more gaskets 640.

FIG. 7C is a schematic representation of a filtration device 600 comprising a first container 605 for receiving unfiltered liquid, which is nested or stacked on a second container 650 for receiving filtered liquid, and a mechanism 630 configured to be removably attached the first container 605. The mechanism 630 further comprises a filter 610 and a chamber housing an adsorbent 620. The mechanism 630 can be attached and sealed with the first container 605 via one or more gaskets 640.

FIG. 7D is a schematic representation of a filtration device 600 comprising a first container 605 for receiving unfiltered liquid, which is nested or stacked on a second container 650 for receiving filtered liquid, and a mechanism 630 configured to be removably attached the first container 605. The mechanism 630 further comprises a filter 610 and a chamber 620 housing an adsorbent. The mechanism 630 can be attached and sealed with the first container 605 via one or more gaskets 640.

Any means may be used to seal the mechanism 630 comprising the filter 610 and chamber 620 and is not limited to heat sealing, gasket, or adhesives.

The chamber 620 may have any adsorbent to facilitate the filtration and purification process and includes but is not limited to cloth, granulated activated carbon, stone, sand, sawdust, cotton, fibers, ion exchange material, ceramic, mesh or any combination thereof. The chamber 620 may precede the filter 610 in series and be used as a pre-filter or the chamber may follow the filter 610 in series. The filtration device 600 may also include both a pre-filter and the chamber 620.

The filter can further be integrated into a filtration system that permits filtration of contaminated water and storage and accessibility of the filtered, purified water as described in the following embodiments.

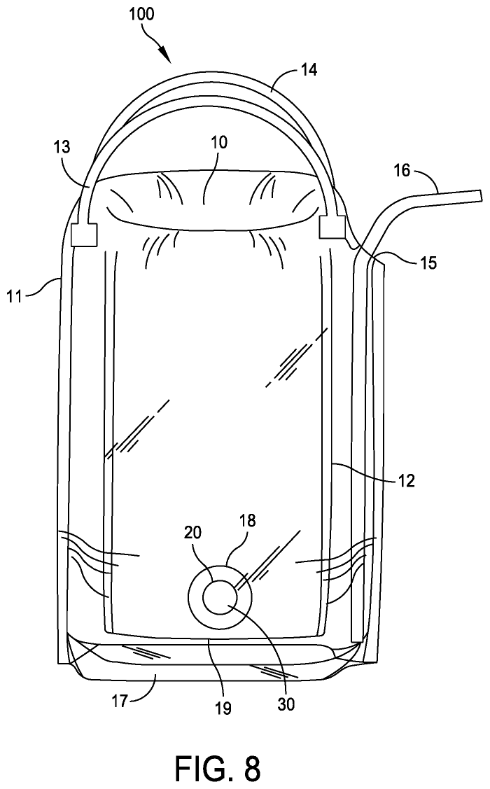

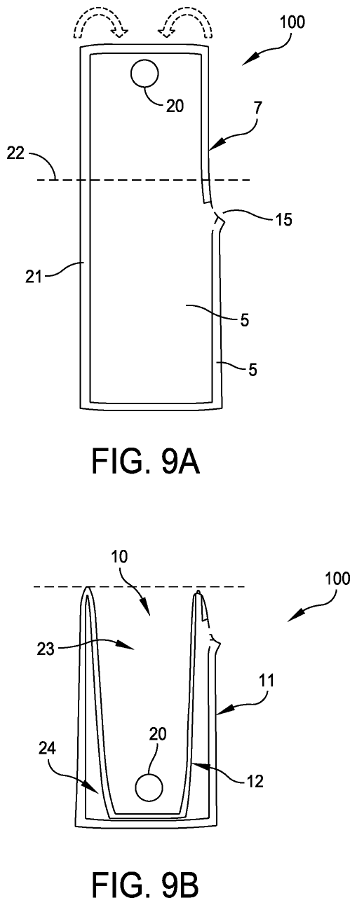

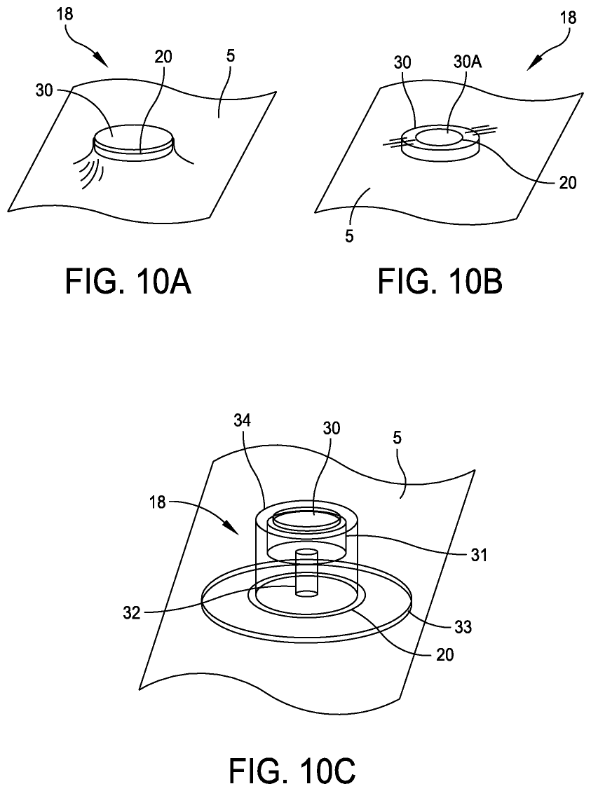

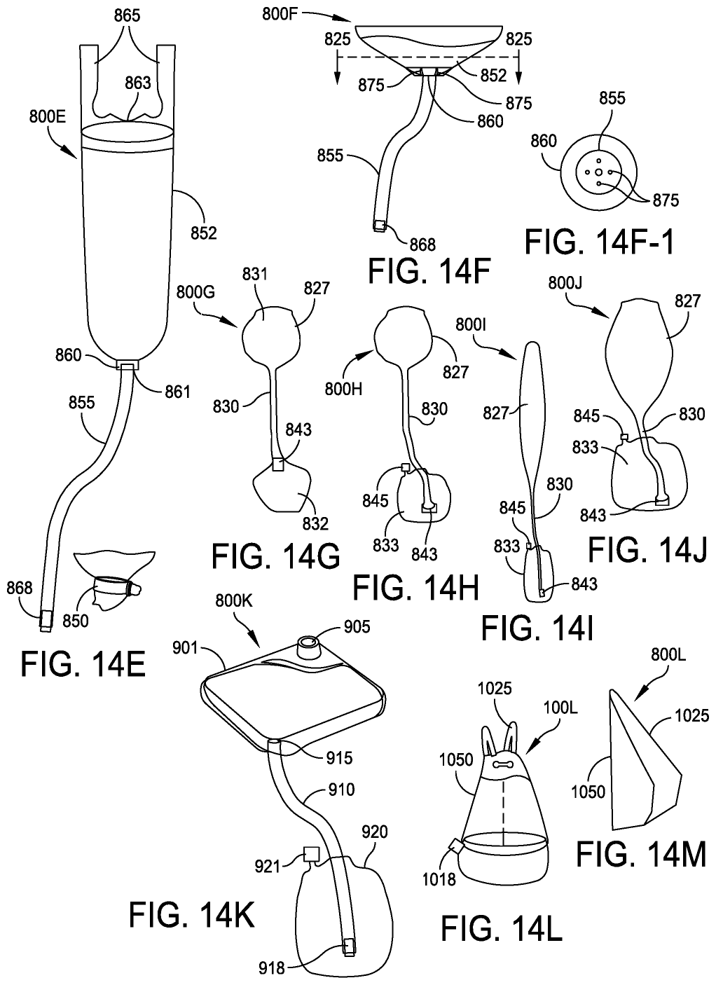

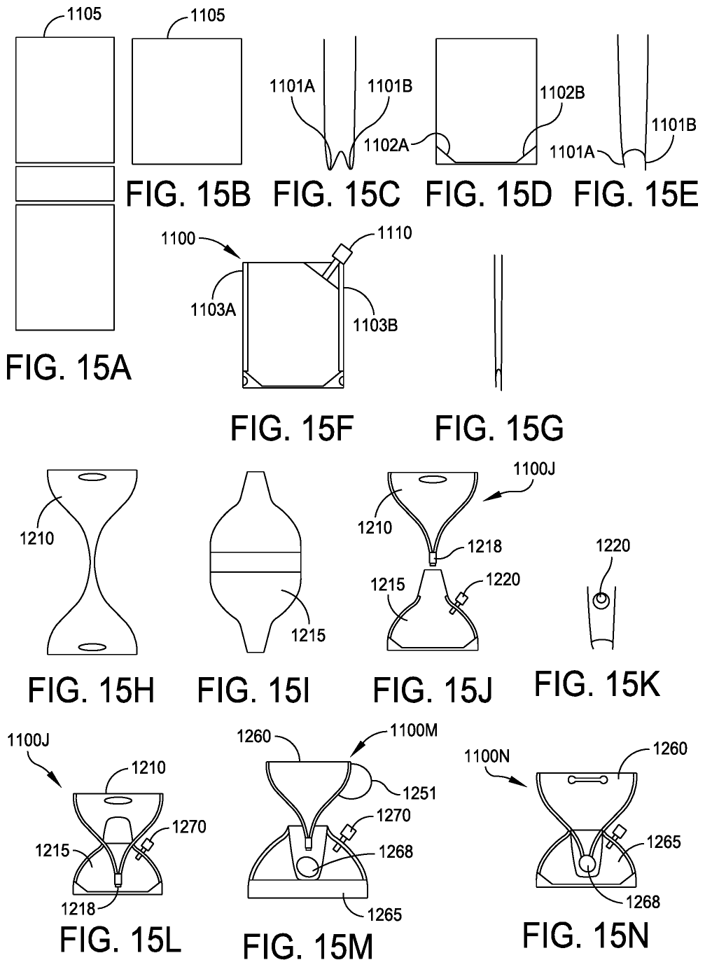

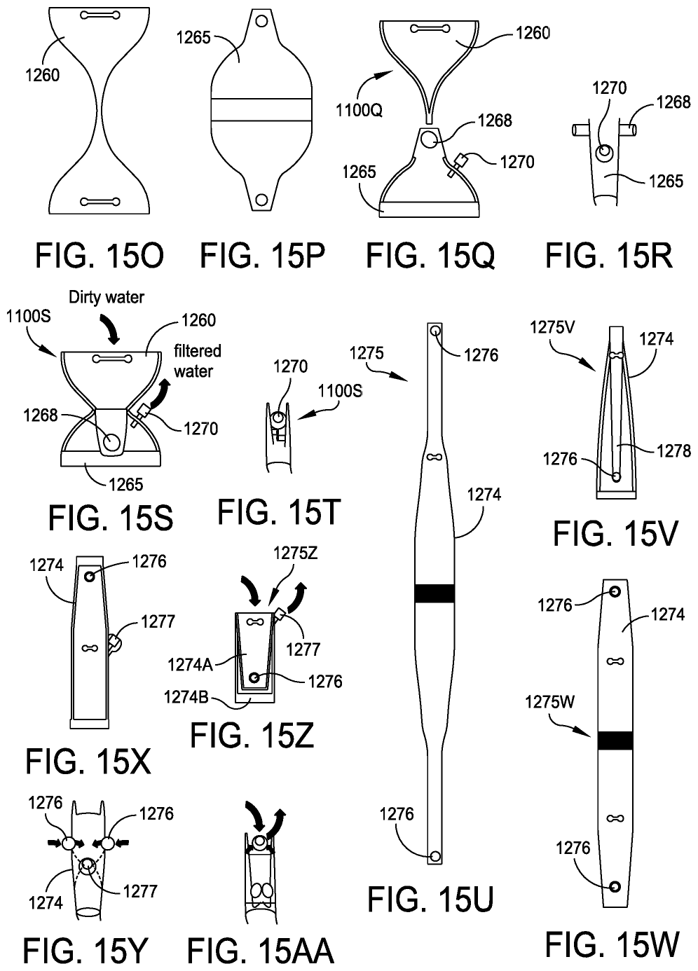

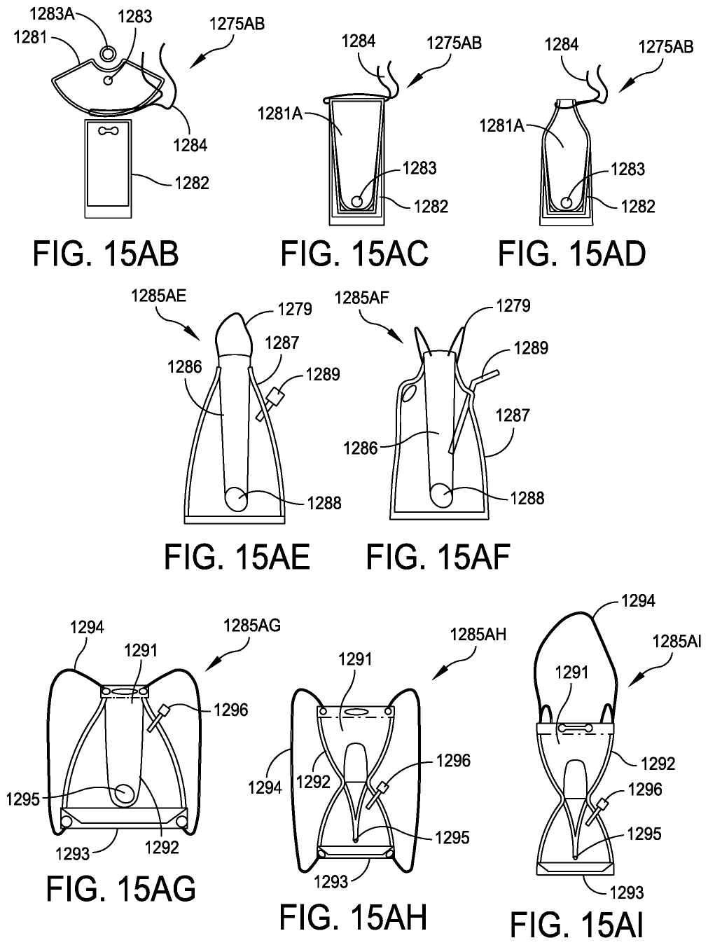

FIG. 8 shows a general concept of a filtration system 100. As illustrated in the figure, the filtration system 100 includes an unfiltered water inlet 10, an outer container 11 and an inner container 12. The outer container 11 and the inner container 12 can be made from sheets of plastic such as polyethylene, polyethylene terephthalate, polypropylene, poly chloride vinyl, poly lactic acid, nylon, poly urethane, or sheets of plant leaf, bark of tree, rubber, silicone, metal, wood, glass, paper and any water-proof material, which are in series and folded, as described in more detail in FIGS. 9A and 9B. The material may further be recyclable or biodegradable. The outer container 11 and the inner container 12 may be flexible, foldable, and can be entirely transparent, partially transparent, or opaque. The outer container 11 and the inner container 12 may include handles 13, 14 to facilitate portability or for hanging. Each handle 13, 14 may be made from same material as the outer container 11 and the inner container 12, and as a single component or two separate components. The outer container 11 may also have outlet 15 to permit access to the inside and outside of the outer container 11. The outlet 15 may be an opening, a protruded spout, or a non-sealed part of the outer container 11 holding a straw 16 as illustrated in FIG. 8. The straw 16 may be longer component such as a tube for drinking or a hose, and may be connected to an external pump, suction, or other mechanism for withdrawing water. Optionally, the straw 16 may be enclosed in a covering that can be removed prior to drinking or removing water that is filtered and collected in the container 11. The covering may be made from the same material as that of one or both of the containers 11 and 12, or a different material. Optionally, the outlet 15 can facilitate decanting filtered water from the outer container 11. A bottom wall 17 of the outer container 11 may be made by sealing two or more sheets of the outer container 11 and the inner container 12 containers or by a process as illustrated in FIG. 8 (made from a single sheet). The sealing may be heat sealing or any other sealing, as described more in detail in FIGS. 10A and 10B. The bottom wall 17 contributes to the filtration system 100 to self-stand with or without contents of the containers 11 and 12. The inner container 12 may have a similar bottom wall 19 as the bottom wall 17 of the outer container 11 shown in FIGS. 8 and 15. The inner container 12 has a filter holding part 18 as described more in detail in FIGS. 10A, 10B, and 10C, holding the filter 30 and connected to a filtered water outlet 20 located on the inner container 12.

The volume of the inner and outer containers may be in a size enabling to contain 150 mL to 5 L liquid, more specifically, 175, 200, 225, 250, 275, 300, 325, 350, 375, 400, 425, 450, 475, 500, 550, 600, 650, 700, 750, 800, or 900 mL, or 1, 1.2, 1.5, 1.7, 2, 2.5, 3, 3.5, 4, 4.5, 5 or 0.75 L. The walls of the inner and outer containers can have a thickness of 125 μm, which may alternately be 10, 20, 30, 40, 50, 60, 70, 80, 90, 100, 110, 120, 130, 140, 150, 160, 170, 180, 190, 200, 210, 220, 230, 240, 250, 260, 270, 280, 290, or 300 μm, or 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5 or 5 mm. The filter can have any height, which may be 0.5, 0.75, 1, 1.25, 1.5, 1.75, 2, 2.25, 2.5 cm or 5 cm. Any of the filters, including modifications and combinations with sorbents as described herein, may be used in the filtration system. When folded, the filtration system may weigh less than 500 g, 300 g, 200 g, 100 g, or 50 g, and may have a volume of less than 1 L, 500 mL, 300 mL, 200 mL, 100 mL, 50 mL.

The filtration system and the filter may be sterilized with treatments such as heat treatment, autoclaving, hot water, chemical sterilization, oxidization, ultraviolet irradiation, gamma irradiation, or a combination of any of these or other sterilization methods. The heat treatment may be UHT (Ultra-High Temperature) sterilization conducted over 100° C., for example, 120° C., including moist and dry heat sterilization. The moist heat sterilization uses temperatures of 110-155° C., for up to 40 minutes, for example, 135, 145 or 150° C. for 1-2 seconds, 1 minute, 10-15, or 20-30 minutes, the time being shorter the higher the temperature. The dry heat sterilization uses longer times of susceptibility that may last up to 2 hours and that use temperatures 160-180° C. In addition, the filter and its package may be treated with hot water (70-100° C.), warm water (40-65° C.), ethanol, methanol, urea, any preservatives, or any aseptic processing. These treatments may be done after the wood is cut and debarked, before being dried and used. In some cases, the wood may be kept wet in preservative.

Further referring to FIG. 8, in one embodiment, unfiltered water, introduced to the filtration system 100 from the inlet 10, reaches the bottom wall 19 inside the inner container 12 by gravity, and is then filtered by passing through the filter 30 located in the filter holding part 18. The filtered water is forced to go out from the inner container 12 to inside of the outer container 11 through the filtered water outlet 20. If no external pressure or suction is applied, filtration can continue as long as the level of water in the inner container 12 is higher than the level of water in the outer container 11. The filtered water may be stored inside the outer container 11 and outside the inner container 12, or removed from the filtration system 100 through the outlet 15 or straw 16 for drinking or other use.

In some embodiments, the filtration system may comprise a flexible bag. The flexible bag may comprise one or more sheets that can be folded into a desired shape for storage of contaminated liquid, attachment of the filter holding part, and effecting filtration of the contaminated liquid. The flexible bag may be folded into any suitable shape to hold contaminated liquid and direct the contaminated liquid towards the filter. Examples of suitable shapes include rectangular, square, triangular, round, bell-shaped, or trapezoidal. The flexible bag can have any thickness, which may be 10, 20, 30, 40, 50, 60, 70, 80, 90, 100, 110, 120, 130, 140, 150, 160, 170, 180, 190, 200, 210, 220, 230, 240, 250, 260, 270, 280, 290, 300 μm, or 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5 or 5 mm.

The embodiment of FIG. 9A shows the filtration system 100 comprising one or more folded sheets 5 to form the flexible bag 7. A method to fold the sheets 5 is illustrated in FIGS. 9A and 9B. As shown in FIG. 9A, two sheets 5 such as plastic sheets having an identical shape, for example, rectangular, square, triangular, round, bell-shaped, or any other suitable shape, are overlapped with each other, and then heat-sealed, bonded, adhered, caulked or sealed with any other water-proof, food-grade adhesion method at a circumference of an edge 21 except at outlet 15 if it is desired. The filtration system 100 may also be made from a single sheet as shown in FIG. 15, where the two sheets 5 of FIG. 9A are joined together at the bottom edge or side edge so as to constitute a single sheet. At least one of the sheets may include the filtered water outlet 20, and the filter 30 may be mounted on the filtered water outlet 20 with or without the filter holding part 18 at a time of the sealing of the two sheets, before or after the sealing. There may be multiple filtered water outlets 20 corresponding to multiple filters and filter holders. A location of the filtered water outlet 20 may be at a bottom of the inner container 12, a lower part of a side wall of the inner container 12, with any angle of the filter 30. The filter holding part 18 may be mounted on the one of the sheets before, after or at the time of the sealing, as described more in detail in FIGS. 10A, 10B, and 10C. Once the sheets 5 are sealed, a part including the filtered water outlet 20 may be folded inside-out as shown with dotted arrows in FIG. 9A, toward an inner space of the two sheets made by the sealing, newly making the unfiltered water inlet 10 around a virtual dotted line 22 by continuously folding the part of the sealed sheets inside-out until the line 22 or until the part of the sealed sheets being folded reaches an opposite bottom inside of the two sheets. When the sheets are sufficiently folded as illustrated in FIG. 9B, a space 23 for unfiltered water communicating to the inlet 10 and the filtered water outlet 20, and another space 24 for filtered water, surrounding the space 23 and communicating to the filtered water outlet 20 and the outlet 15, are created. Consequently, the outer container 11 surrounds the inner container 12 with the space 24 in between, the space 23 is defined by the inner container 12, and the space 24 is defined by the containers 11 and 12. The outer container 11 may be premanufactured to contain a juice, a beverage, a flavoring, electrolytes, or other food-grade liquids or powders (such as powders of Fanta® or POCARI SWEAT®) in space 24 for adding taste, flavor, nutrition, or supplements to the filtered water. Additionally, material such as chlorine (in the form of sodium hypochlorite), silver nanoparticles, copper salts, iron salts (such as iron chloride), or materials that release disinfectants or other functional substances in a controlled manner, may be included in the outer container 11.

With the above-mentioned filtration system, it is easy to manufacture an affordable filter apparatus with a small number of parts, to obtain sufficient water head and flow rate, and to incorporate commonly-available parts and low-cost parts.

The filter may be contained in a filter holding part, which may be integrated into a wall of one or more of the containers of the filtration system, may form naturally due to a tapering structure of the filtration system (e.g. bell shape), or can be removably attached to the filtration system. In some embodiments, the filter holding part may be tubing, a flange, plug, an insert, or other structure that permits quick and easy attachment and removal of the filter to the filtration system.

In some instances, the filter holding part 18 may be a part of one of the two sheets, as illustrated in FIGS. 10A and 10B. As shown in FIG. 10A, one way of forming the filter holding part 18 is to make a hole forming the filtered water outlet 20 smaller than a diameter of the filter 30 in a sheet 5, and to partially push the filter 30 out from the hole along a longitudinal direction of the filter 30 while the filtered water outlet 20 is heat-sealed, bonded, or sealed with any other water-proof, food-grade adhesion with the filter 30. The circumferential surface of the filter 30 may be used for the sealing with the filtered water outlet 20, as shown in FIG. 10A.

As illustrated in FIG. 10B, another way of forming the filter holding part 18 is to seal the filter 30 with use of a surface 30A of the filter 30 instead of its circumferential surface as in FIG. 10A. The surface 30A used in the sealing can be either the first surface of the filter comprising the feed side or the second surface of the filter comprising the filtrate side. This sealing of a surface 30A of the filter 30 may also be accomplished via heat-sealing, bonding, or sealing with any other water-proof, food-grade adhesion.

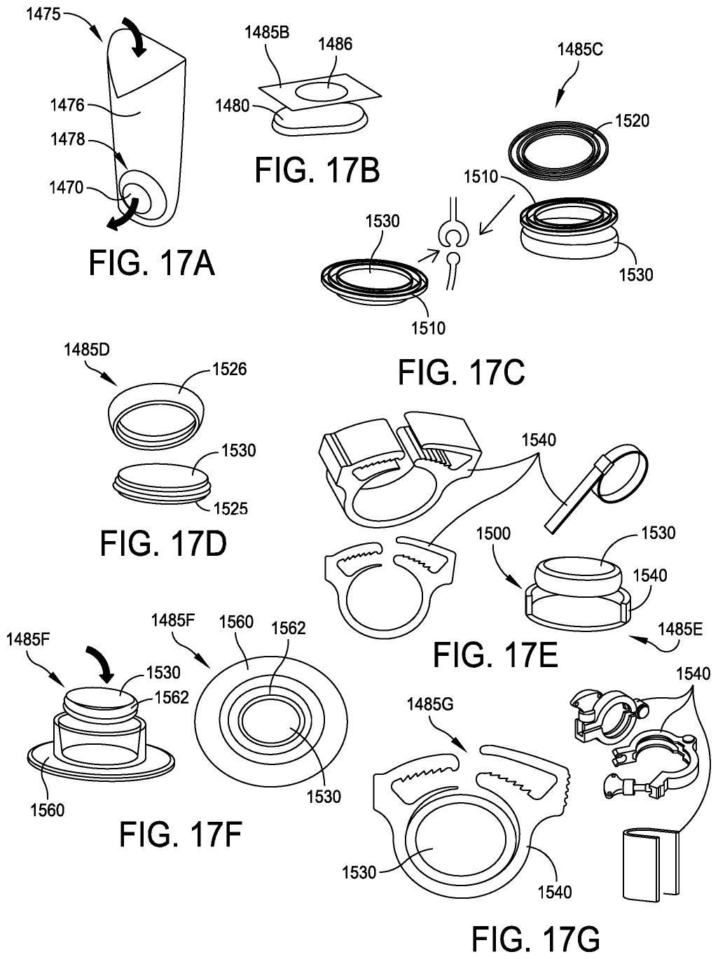

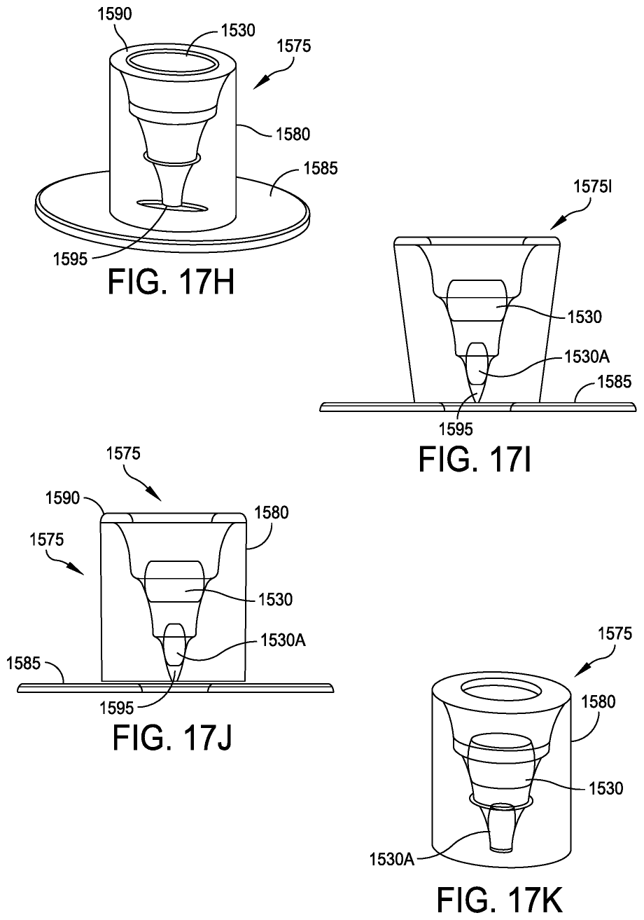

As illustrated in FIG. 10C the filter holding part 18 can be made of flexible material such as latex, silicone or any kind of rubber, rubbery flexible material in a cylindrical structure 34, which allows users to easily replace the filter 30 as necessary without damaging the filtration system. The filter 30 is securely held in an inner hole 31 of the filter holding part 18, sealing at a circumferential surface of the filter 30 with stretching the inner hole 31 of the filter holding part 18 outwardly in a radial direction of the filter 30. In the embodiment of FIG. 10C, the filter holding part 18 may have a filtered water path 32 adjacent to the inner hole 31, and a flange 33 to seal with the one of the sheets 5. The flange 33 of the filter holding part 18 and the inner hole 31 of the filter holding part 18 are oppositely disposed so as to be located in a space in which unfiltered water is filled and preventing a space for filtered water stored in the back side of the one of the sheets from any contamination of filter replacement. The cylindrical structure 34 of the filter holding part 18 made with the flexible material may be directly attached to the one of the sheets 5 without the flange 33, via utilizing adhesive material or injection molding as an extended part of the filtered water outlet 20. Alternately, the filter holding part 18 may be formed as illustrated in FIG. 17. In some embodiments, the filter may be a non-circular convex shape, and the filter holder may have a circular or non-circular shape such that it contacts the circumference of the filter after the filter is mounted in the holder. The thickness of the filter holder may be such that the inner hole 31 is pressed against the circumference of the filter.

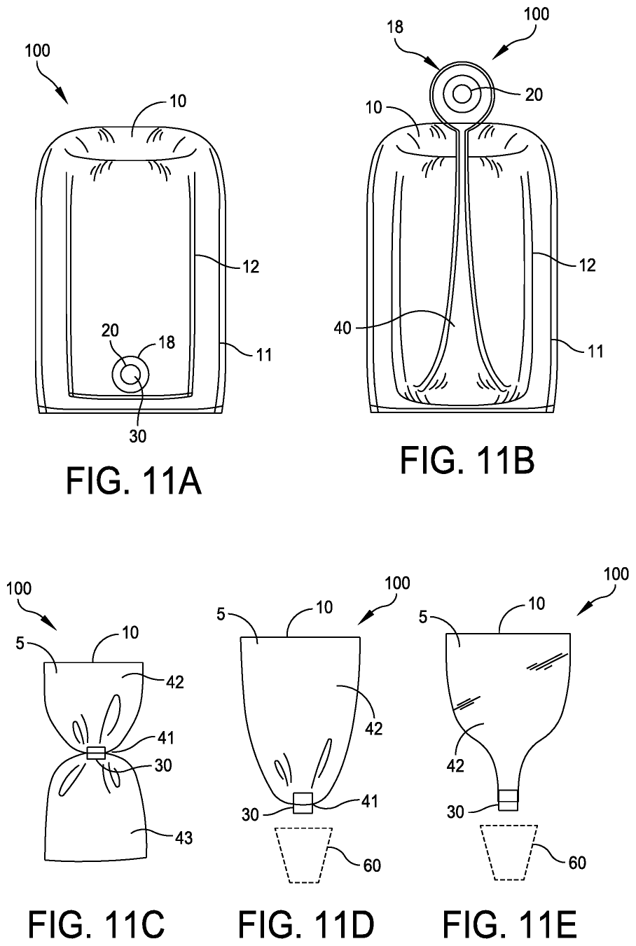

The filtration system 100 may have various shapes as illustrated in FIGS. 11A, 11B, 11C, 11D, and 11E.

In embodiments in which a handle and a straw are not required, the filtration system 100 may be in a shape as shown in FIG. 11A. The embodiment of FIG. 11A includes an inner container 12 nested in an outer container 11, and an inlet 10 for the water or liquid to be filtered to be fed into the inner container 12. The inner container 12 comprises an outlet 20 including the filter holding part 18, which holds the filter 30. The water or liquid to be filtered enters the filtration system 100 via the inlet 10 into the inner container 12 and flows through the filter 30 held by the filter holding part 18 via the outlet 12 into the outer container 11, which stores the filtered water or liquid.

In some embodiments, features such as ribs, trusses, or thicker sheets may be used to provide structural support to enable the filtration system to stand on a surface. A combination of stiff and flexible sheets may be used to provide structural integrity while retaining some flexibility. The materials used in these embodiments are sheets such as plastic sheets and wood as filter; or the sheets, the wood and flexible material such as silicone as filter holding part.

In some embodiments, the filter holding part 18 may be formed with an elongated part 40 made by further folding a bottom part of the inner container 12 towards the inlet 10 as illustrated in FIG. 11B. This structure may help users to replace filters at the filter holding part 18 by easily reaching the filter holding part 18 extended near or above the inlet 10, and dropping it off to the bottom part of the inner container 12.

The filtration system 100 may be formed by squeezing the sheets 5 into a shape of a bag as illustrated in FIGS. 11C and 11D, instead of folding the sheets as described above. The shape of the bag may be in a rectangular shape with two sides and a bottom side being sealed, or any other bag shape, which is able to contain water itself. The bag material may be plastic, plant leaf, bark of tree, rubber, silicone, paper or any waterproof material. In one instance, the filter 30 may be sealed, heat-sealed, bonded, or attached with magnet or by any waterproof, food-grade adhesive material with a squeezed side wall of the bag. The filter holding part 41 in this structure is made by squeezing or cinching the bag to form a taper and attaching the filter 30 to the taper or placing the filter 30 within the taper.

As illustrated in FIG. 11C, the filter holding part 41 may be placed between the inlet 10 and a space 43 for collection of filtered water or liquid at the bottom of the bag. The water or liquid to be filtered enters the filtration system 100 via the inlet 10 and is stored in a space 42, wherein the water or liquid to be filtered flows through the filter 30, held by the filter holding part 41 into the space 43 for collection of filtered water or liquid.

As illustrated in FIG. 11D, the filter holding part 41 may be placed at the bottom of the bag, which has been folded into the shape of a parabola. The filtration system 100 as shown in FIG. 11D only contains a space 42 for unfiltered water or liquid wherein the filter holding part 41, holding the filter 30 is placed at the vertex of the parabola. In operation, the water or liquid to be filtered enters space 42 of the filtration system 100 via the inlet 10, wherein the water or liquid passes through the filter 30 via gravity. An external container 60 is used to collect the filtered water or liquid.

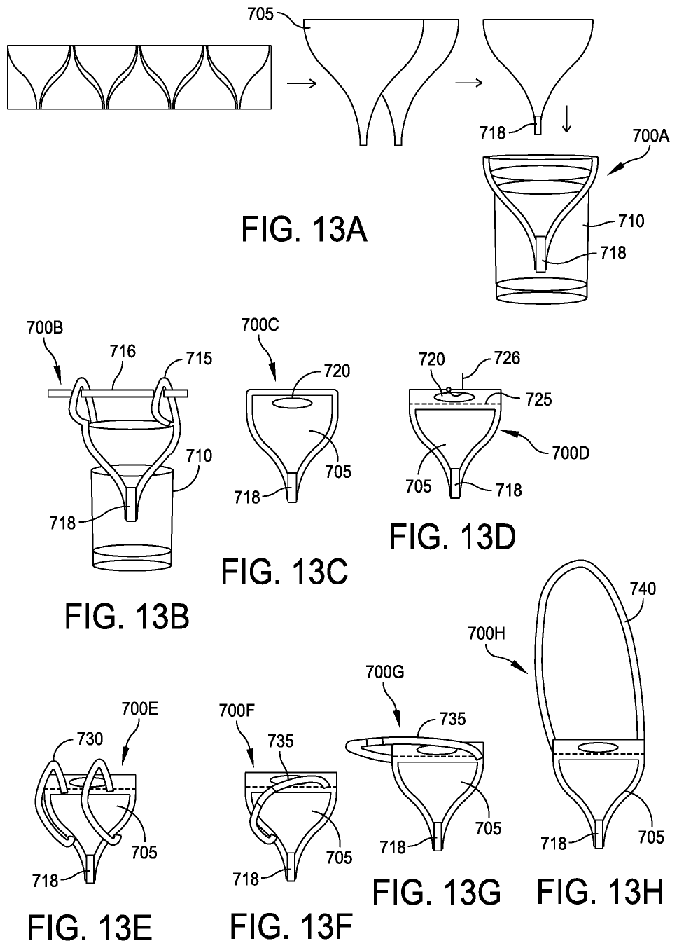

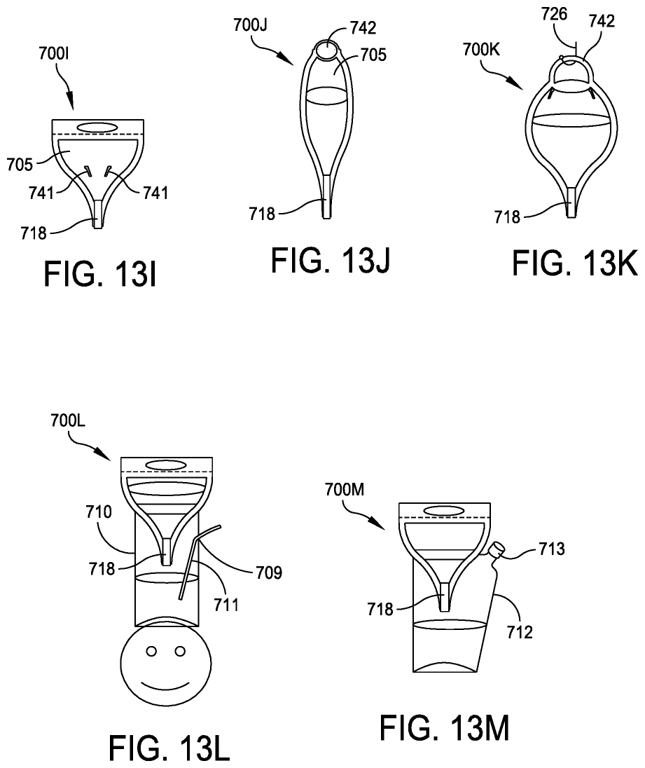

The filtration system 100 may include two materials—a bag material and a filter material; or three materials—a bag material, a filter material and a flexible holder or adhesive material for the filter holding part. To reduce waste of a bag material and to store and filter unfiltered water efficiently, the filtration system 100 may have a bell-like shape as illustrated in FIG. 11E. This shape may be obtained from sealing two bell-shaped sheets 5 at two sides, and sealing with the filter 30 at a bottom. More detailed structures of these embodiments are described with reference to FIG. 13. An external container 60 for storage of filtered water or liquid may be used.

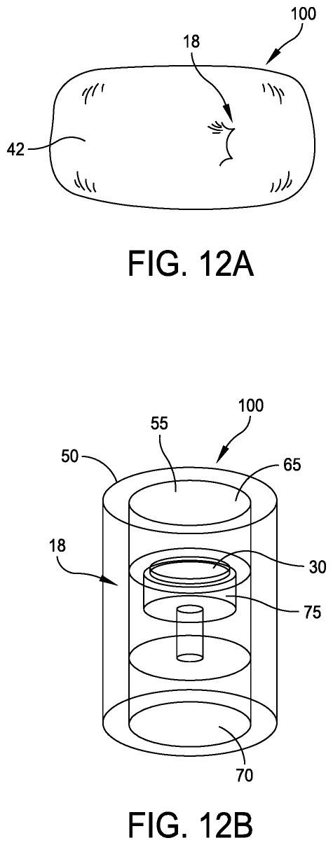

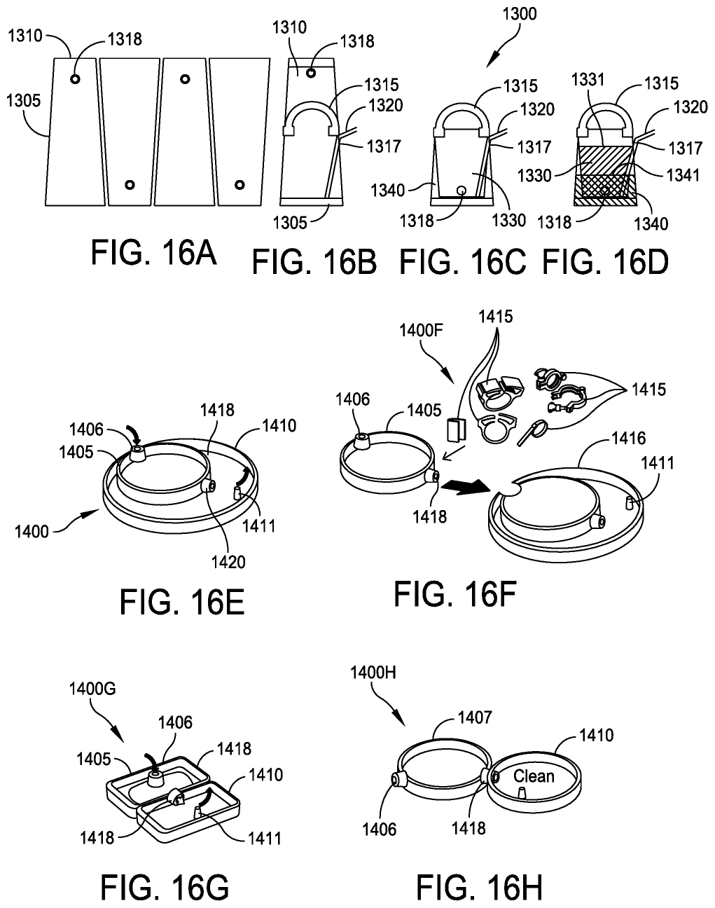

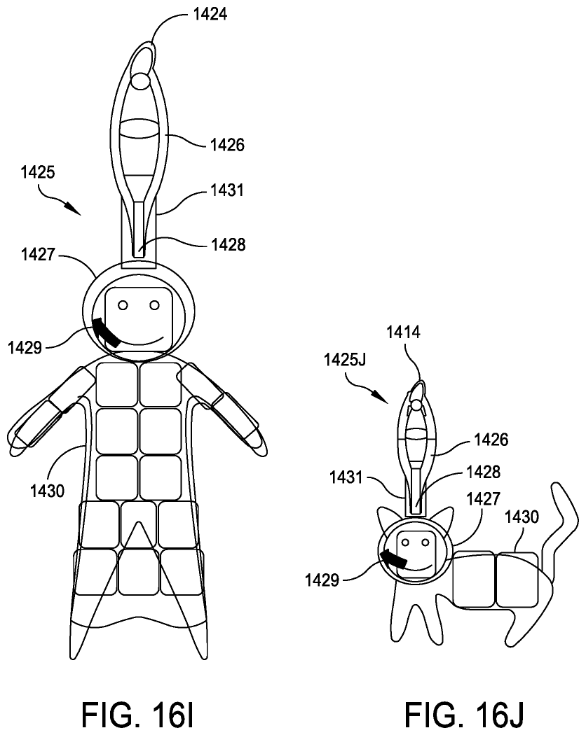

In the embodiment shown in FIG. 12A, the filtration system 100 may be in a cushion or pillow shape. This shape may allow users to take a seat or place a head on the filtration system 100, and add pressure to unfiltered water in the space 42. The space 42 and the filter holding part 18 may be formed by methods as described above or by any combination of above-mentioned methods. More detailed structures of the shapes are described in connection with FIG. 16.

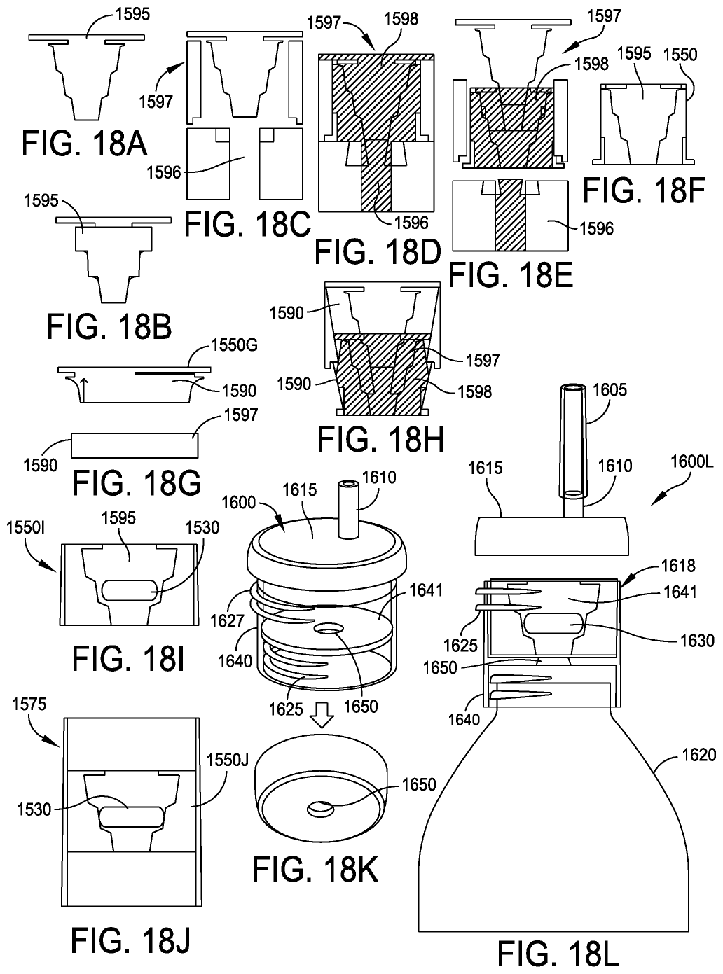

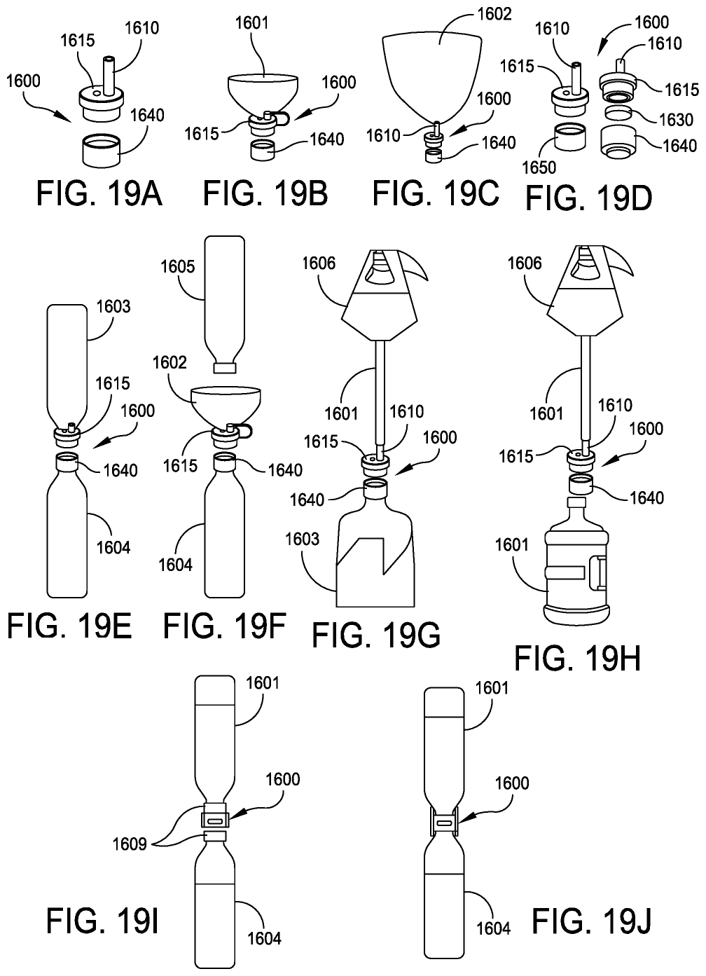

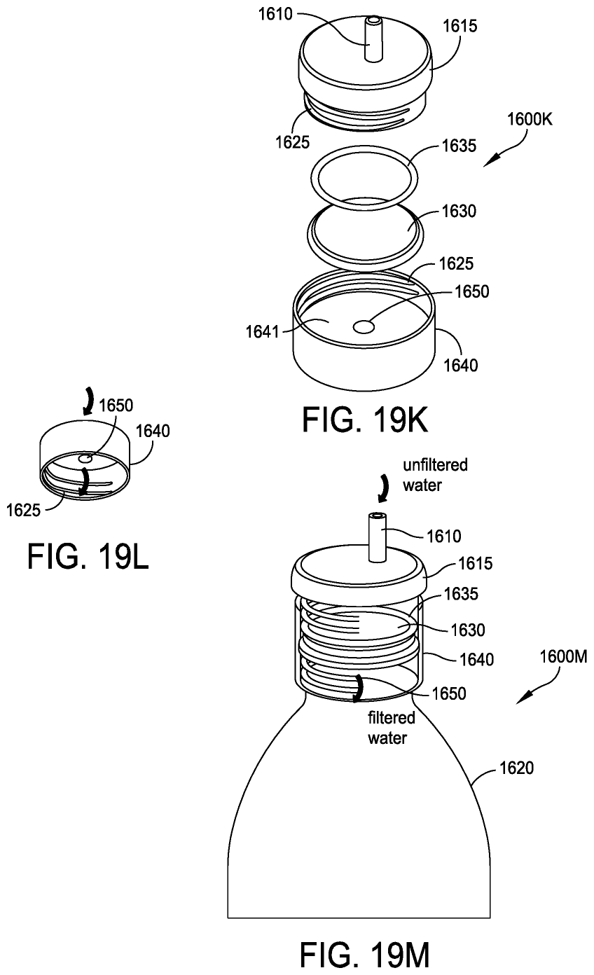

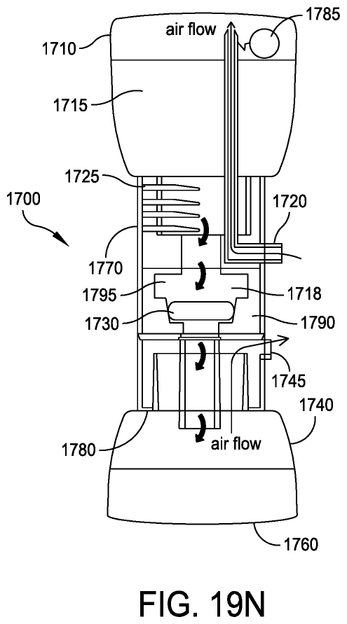

As illustrated in FIG. 12B, the filtration system 100 may be in a form of a bottle cap. The filter holding part 18 may be formed in a same way as described in FIG. 10C without a flange, and placed in a barrel 50 having a bore 55 wherein the bore 55 has a first end 65 and a second end 70. The barrel 50 may have screws, a notch or a cavity in an inner wall, threads, or any other fastening mechanism to enable the filtration system 100 to be connected with conventional bottles, containers, bags, pipes, or faucets. The filter holding part 18 may be disposed inside the bore 55 of the barrel 50 between the first end 65 and the second end 70 of the bore 55. The filter holding part 18 may define a recess 75 holding the filter 30. The first end 65 and the second end 70 of the bore 55 may have screw threading, teeth, or other means of removably connecting the barrel 50 to a first container and a second container (not shown). More detailed structures of the bottle cap are described in connection with FIGS. 18 and 19.

FIGS. 13A-13M depict some embodiments of a filtration system 700. As depicted in FIG. 13A, one way of making a filtration system 700A having the bell-shaped container described in FIG. 11E may be to cut the commercially-available plastic sheets into multiple bell-shaped parts 705 with or without a gap between each other, overlap and heat-seal two of the bell-shaped parts at both sides and at a tapered bottom having a filter 718. The plastic or sheet material may be, as following but not limited to, polyethylene, polyethylene terephthalate, polypropylene, poly chloride vinyl, poly lactic acid, nylon, poly urethane, latex, silicone, potato or corn starch-based plastic, any starch-based plastic, sea-weed-based plastic, plant leaf, bark of tree, paper, cloth, wood, gourd, bamboo, metal, any plant-based or non-plant-based plastic. In the embodiment of FIG. 13A, the filtration system 700A may be placed over a container 710 for collection and storage of the filtered water or liquid.

A variety of modifications to the shape of the filtration system 100 may be made as well.

FIG. 13B shows an embodiment of a filtration system 700B having two straps 715, which can be hung on a rod 716 and placed over a container 710 for filtration of water or another liquid through filter 718. In this embodiment, hanging of the filtration system 700B on the rod 716 allows gravity to direct the flow of water or liquid through the filter and into the container 710 for collection and storage.

FIG. 13C shows another embodiment of a filtration system 700C, wherein a handle hole 720 is cut out from the sheets 705 through which the user can hold or transport the filtration system 700C or through which a rod or hanger (not shown) can be threaded such that the filtration system 700C can be hung to permit gravity to direct the flow of water or liquid through the filter.

FIG. 13D shows another embodiment of a filtration system 700D, wherein the sheets 705 comprise a zipper or a sliding channel 725 to permit opening and closing of the filtration system 700D. The filtration system 700D of FIG. 13D also contains the handle hole 720 through which a hanger 726 or rod (not shown) can be threaded such that the filtration system 700D can be hung to permit gravity to direct the flow of water or liquid through the filter.

FIG. 13E shows another embodiment of a filtration system 700E comprising one or more straps 750, which can be single size or adjustable, wherein the straps can be mounted to the sheets 705 and aligned parallel along the length of the bell-shaped sheet 705 such that the filtration system 700E can be transported by wearing it on the user's back.

FIG. 13F shows another embodiment of a filtration system 700F comprising a belt 735, which can be single size or adjustable, and can be mounted to the sheets 705 diagonally across the length of the sheets 705 such that the filtration system 700F can be transported by wearing it cross-body.

FIG. 13G shows another embodiment of a filtration system 700G comprising a belt 735, which can be single size or adjustable, and can be mounted to the sheets 705 across the width of the sheets 705 such that the filtration system 700G can be transported by wearing it on the waist.

FIG. 13H shows another embodiment of a filtration system 700H comprising a strap 740, which can be single size or adjustable, and can be mounted to the sheets 705 across the width of the sheets 705 such that the filtration system 700H can be transported by wearing it on the shoulder or neck.

FIG. 13I shows another embodiment of a filtration system 700I, wherein a wall of the sheets 705 are tucked into creases 741 to form a three-dimensional shape.

FIG. 13J shows another embodiment of a filtration system 700J, wherein the sheets 705 have an elongated bell shape and may include a handle 742 to facilitate transport and handling or hanging (not shown) of the filtration system 700J.

FIG. 13K shows another embodiment of a filtration system 700K, wherein the filtration system has rigid convex-shaped walls and may include a handle 742 to facilitate transport and handling or hanging of the filtration system 700K on a hanger 726.

FIG. 13L shows another embodiment of a filtration system 700L, wherein the container 710 that receives the filtered water or liquid further comprises a spout or an opening 709 for the insertion of a straw 711 to permit use of the filtration system 700L as a drinking bag.

FIG. 13M shows another embodiment of a filtration system 700M, wherein the container 710 that receives the filtered water or liquid further comprises a spout 713 to permit access to the filtered water or liquid contained and stored in the filtration system 700M.

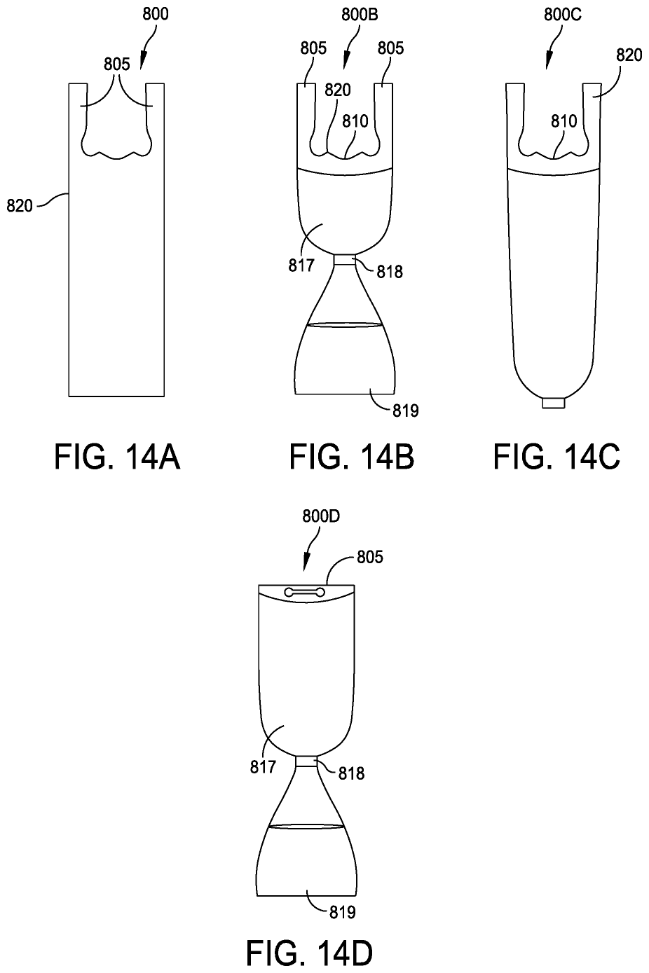

FIGS. 14A-14M show other embodiments in which the shape of the flexible bag of the filtration system may be further modified. The flexible bag of the filtration system may be shaped or formed from conventional biodegradable bags such as EcoSafe-6400® or any conventional plastic bag.

As shown in FIG. 14A, the filtration system may be formed from any bag such as a biodegradable bag 820. The biodegradable bag 820 may contain one or more handles 805, which may be made to be contiguous with the material of the biodegradable bag 820 or separately attached to the biodegradable bag 820 (not shown). The biodegradable bag 820 can have any length or width, wherein the length of the one or more handles 805 can be included in the overall length of the biodegradable bag 820. In some embodiments, the length of the biodegradable bag 820 can be between 12 and 60 inches long and between 12 and 60 inches wide. In some embodiments, the handles 805 can be between 4 and 10 inches long.

FIG. 14B shows one embodiment of a filtration system 800B utilizing the biodegradable bag 820 wherein the biodegradable bag 820 is compressed and cinched to form a taper in which a filter holding part 818 holding the filter (not shown) may be inserted. The taper divides the biodegradable bag into a first space 817 having an inlet 810 in which water or liquid to be filtered is fed and a second space 819 into which filtered water or liquid flows after passing through the filter housed in the filter holding part 818. The second space 819 may be sealed to contain the filtered water or liquid or may be open via a slit or spout (not shown) to permit access to the filtered water or liquid. The filtration system 800B may include handles 805, which may be used to transport the filtration system 800B or used to hang or suspend the filtration system 800B to facilitate filtration via gravity.

FIG. 14C shows another embodiment of a filtration system 800D wherein the filter holding part 818 is sealed to the bottom of the biodegradable bag 820 such that filtered water or liquid flows out via the filter holding part 818 with the assistance of gravity. The filtration system 800C may include handles 805, which may be used to transport the filtration system 800C or used to hang or suspend the filtration system 800 to facilitate filtration via gravity.

FIG. 14D shows another embodiment of the filtration system 800D wherein the biodegradable bag 820 may be compressed and cinched to form a taper in which a filter holding part 818 holding the filter (not shown) may be inserted. The taper may divide the biodegradable bag into a first space 817, which may have a seal 815 to enclose and contain the water or liquid to be filtered, and a second space 819 into which filtered water or liquid flows after passing through the filter housed in the filter holding part 818. The second space 819 may be sealed to contain the filtered water or liquid or may be open via a slit or spout (not shown) to permit access to the filtered water or liquid.

FIG. 14E shows an embodiment of a filtration system 800E comprising a biodegradable bag 852 wherein the biodegradable bag 852 comprises an outlet 860 at its bottom, wherein the outlet 860 is connected to one end 861 of tubing 855, and wherein a filter 868 is embedded within a second end 862 of the tubing 855. The biodegradable bag 852 can also comprise one or more handles 865 which may be used to transport the filtration system 800E or used to hang or suspend the filtration system 800E to facilitate filtration via gravity. A pre-filter 863 can also be affixed to the opening of the biodegradable bag 852. Pre-filters are described in more detail below.

Any means can be used to secure the tubing 855 to the outlet 860. In some embodiments, the tubing 855 is secured to the outlet 860 via hose clamp 850. In some embodiments, the tubing 855 is heat sealed to the outlet 860. In some embodiments, the outlet 860 is configured as a female part to connectively accept the tubing 855 as a male part.

FIG. 14F shows another embodiment of a filtration system 800F wherein the tubing 855 comprises needle protrusions 875 that can puncture the biodegradable bag 852 at the outlet 860. The biodegradable bag may be sealed at the outlet by any means that facilitate access by puncturing or piercing, which may include, but not limited to a septum, a cork, cap, lid, or other covering that can be pierced or punctured.

FIG. 14F-1 shows a cross section of the embodiment of filtration system 800F taken along line 825 of FIG. 14F showing the tubing 855 having needle protrusions 875, which puncture or penetrate the filtration system 800F at the outlet 860.

FIG. 14G shows another embodiment of a filtration system 800G, wherein tubing 830 can be integrated with a biodegradable bag 827, wherein the integrated tubing 830 divides the biodegradable bag 827 into a first chamber 831 and a second chamber 832, and wherein the tubing 830 further comprises a filter 843.

FIG. 14H shows another embodiment of a filtration system 800H, wherein the tubing 830 is integrated with the biodegradable bag 827 to form one contiguous piece at one end and comprising the filter 843 at the opposite end. The tubing 830 can be extend into a separate container 833 for collection and storage of filtered water or liquid, wherein container 833 has a spout 845 to permit access to the water or liquid.

FIG. 14I shows another embodiment of a filtration system 800I, wherein the biodegradable bag 827 has an elongated shape. The tubing 830 is integrated with the biodegradable bag 827 to form one contiguous piece at one end and comprising the filter 843. The tubing 830 can be extend into a separate container 833 for collection and storage of filtered water or liquid, wherein container 833 has a spout 845 to permit access to the water or liquid.

FIG. 14J shows another embodiment of a filtration system 800J, wherein the biodegradable bag 827 has a wide, oblong shape. The tubing 830 is integrated with the biodegradable bag 827 to form one contiguous piece at one end and comprising the filter 843. The tubing 830 can be extend into a separate container 833 for collection and storage of filtered water or liquid, wherein container 833 has a spout 845 to permit access to the water or liquid.

FIG. 14K shows another embodiment of a filtration system 800K having the shape of a cushion or pillow. The cushion 901 may have an inlet 905 through which water or liquid to be filtered is fed, an outlet 915 comprising tubing 910 in which one end of tubing 910 is connected to the outlet 915 and having a filter 918 at the opposite end. Filtration system 800K may also include a container 920 for collection and storage of filtered water or liquid, wherein the second container 920 comprises a spout 921 to facilitate access to the filtered water or liquid.

In operation, the filtration system 800K is filled with water or liquid to be filtered via the outlet 915 and the user rests his or her head, sits, or places a heavy object, such as a stone or a log, on the cushion 901, in which the added weight puts additional pressure on the filtration system 800K to facilitate the filtration process. The filtration system 800K can be manufactured to tolerate a variety of bodyweights. In some embodiments, the filtration system 800K can withstand bodyweights up to 20 kg, 30 kg, 40 kg, 50 kg, 60 kg, 70 kg, 80 kg, 90 kg, 100 kg, 150 kg, or 200 kg without breakage.

FIG. 14L shows another embodiment of a filtration system 800L in accordance with some embodiments. The filtration system 800L may be constructed from, or in the shape of, a tree-watering bag 1050 having one or more straps 1025 on which filter holding part 1018 housing the filter (not shown) can be mounted. A tree watering bag 1050 such as Treegator® may be used for storage of unfiltered water, on which the filter via the filter holding part 1018 may be mounted.

FIG. 14M shows a side view of the bag in the filtration system 800L when the bag is partly folded (other filtration system components are not shown).

For an efficient filtration, to improve the filtration rate or volume filtered by the filtration system, or to improve removal of contaminants including biological or chemical contaminants, an additional pre-filter such as cloth, granulated activated carbon, stone, sand, sawdust, cotton, fibers, ion exchange material, ceramic, mesh or any combination of conventional filter may be used, which is applicable to all above-mentioned embodiments, for example, as shown in part 863 of FIG. 14E. In some embodiments, the additional pre-filters may be cloth or pre-filter affixed to an inlet of container for unfiltered water. Another embodiment of the additional pre-filters may be the above-mentioned pre-filter held by a second filter holder. Yet another embodiment of the additional pre-filters may be enclosed in a packet containing the pre-filter material in the form of powder or dispersion in liquid, to be added into the filtration system before adding unfiltered water. Alternatively, pre-filtration material in power or liquid form may be enclosed inside the filtration system on the unfiltered water side of the filter.

Additional methods of forming the filtration system and their respective embodiments are illustrated in FIGS. 15A-15AI.

To form the container for receiving filtered water of a filtration system 1100 (FIG. 15F), a sheet 1105 as shown in FIGS. 15A and 15B may be folded trice (W-shape in a side view of FIG. 15C), sealed at two ridges 1101A and 1101B (FIG. 15C) of the bottom as well as corners 1102A and 1102B (FIGS. 15D, 15E), and sealed at sides 1103A and 1103B (FIG. 15F, 15G) with a spout 1110 if it is desired.

As shown in FIGS. 15H and 15I, containers for filtered water 1215 and unfiltered water 1210 may be formed separately from a single sheet and sealed at the edges. Either of containers 1210 and 1215 may include the filter 1218 (FIG. 15J). The container for filtered water 1215 may include a spout 1220 (FIGS. 15J, 15K).

As shown in FIGS. 15J and 15L, containers 1210 and 1215 may be attached to each other or detachable from each other.

More in particular, FIG. 15J shows an embodiment of a filtration system 1100J in which the filter 1218 is located at a tapered end of the container for unfiltered water 1210.

As shown in FIG. 15L with respect to the filtration system 1100J, the container for unfiltered water 1210 can be attached to or inserted into the container for filtered water 1215, having a spout 1220 for accessing the filtered water. FIG. 15K is a side view of the filtration system 1100J.

FIG. 15M, shows an embodiment of a filtration system 1100M in which the filter holding part 1268 is located within a container for filtered water 1265, wherein a container for unfiltered water 1260 can be attached to the container for filtered water 1265, having a spout 1270 for accessing the filtered water. The container for unfiltered water 1260 may include a handle 1251 to facilitate transport of the container 1260.

In filtration system 1100N, shown in FIG. 15N, the container for unfiltered water 1260 has a tapered end that can be connected to the filter holding part 1268 to effect filtration of unfiltered water within the container 1265.

FIGS. 15O and 15P show alternative embodiments of sheets used to form containers 1260 and 1265 wherein container 1265 is configured to include the filter holding part 1268.

FIGS. 15Q and 15R show an embodiment of the filtration system 1100Q in which the filter holding part 1268 is located in the container 1265 for filtered water. The container 1265 for filtered water also contains a spout 1270 for accessing the filtered water.

FIGS. 15S and 15T show an embodiment of the filtration system 1100S in use in which unfiltered water is fed into container 1260, wherein the water flows through filter holding part 1268 housing the filter (not shown) into container 1265, and wherein filtered water can be accessed via the spout 1270.

FIG. 15U shows another embodiment of a filtration system 1275 in which an elongated sheet 1274 having one or more filter holding parts 1276 can be folded into a container of the filtration system 1275.

FIG. 15V shows the folded sheet 1274 as container having a narrow bottle shape wherein the container includes a channel 1278 for filling with unfiltered water, which is connected to the one or more filter holding parts 1276 to form filtration system 1275V.

FIG. 15W shows another embodiment of the filtration system 1275W in which an elongated sheet 1274 having one or more filter holding parts 1276 can be folded into a container of the filtration system 1275W.

FIG. 15X shows the folded elongated sheet 1274 comprising spout 1277 prior to formation of an internal container comprising the one or more filter holding parts 1276. FIG. 15Y is a side view of the folded elongated sheet 1274 of FIG. 15X.

FIG. 15Z shows a filtration system 1275Z in which the portion of the folded elongated sheet 1274 of FIG. 15X has been tucked and formed into an internal container 1274A comprising one or more filter holding parts 1276, which permit flow of water into an external container 1274B. Filtered water can be accessed from the spout 1277. FIG. 15AA shows a side view of the filtration system 1275Z.

FIG. 15AB shows another embodiment of a filtration system 1275AB comprising a sheet 1281 having a filter holding part 1283 housing a filter 1283A, wherein the sheet 1281 can be folded and nested within an outer container 1282 as an inner container 1281A, wherein a string 1284 can be used to cinch or taper the sheet 1281 and container 1282 (FIGS. 15AC, 15AD).

FIG. 15AE shows another embodiment of a filtration system 1285 comprising an inner container 1286 nested within an outer container 1287, wherein the inner container 1286 has a filter holding part 1288 housing a filter (not shown). The filtration system 1285 may include a spout 1289 and comprise a strap 1279 to facilitate transport of the filtration system 1285.

FIG. 15AF shows another embodiment of a filtration system 1285AF comprising an inner container 1286 nested within an outer container 1287, wherein the inner container 1286 has a filter holding part 1288 housing a filter (not shown). The filtration system 1285AF may include a spout 1289 in the form of a straw and comprise one or more straps 1279 to facilitate transport of the filtration system 1285AF.

FIG. 15AG shows another embodiment of a filtration system 1285AG comprising an inner container 1292 nested within an outer container 1293, wherein the inner container 1292 has a filter 1295. The filtration system 1285AG may include a spout 1296 for accessing filtered water and comprise one or more straps 1294 to facilitate transport of the filtration system 1285AG.

FIG. 15AH shows another embodiment of the filtration system 1285AH having an hourglass shape comprising an inner container 1292 connected to an outer container 1293, wherein the inner container 1292 has a filter 1295. The filtration system 1285AH may include a spout 1296 for accessing filtered water and comprise one or more straps 1294 to facilitate transport of the filtration system 1285AH.

FIG. 15AI shows another embodiment of a filtration system 1285AI having an hourglass shape comprising an inner container 1292 connected to an outer container 1293, wherein the inner container 1292 has a filter 1295. The filtration system 1285AI may include a spout 1296 for accessing filtered water and comprise one or more straps 1294 to facilitate transport of the filtration system 1285AI.

FIGS. 16A-16J show other embodiments of the filtration system utilizing the wood filter.

FIG. 16A shows sheets 1310, wherein one or more of the sheets 1310 includes a filter holding part 1318 that houses a filter (not shown) at one end, wherein the sheets 1310 are overlapped with each other and wherein edges 1305 of the overlapped sheets 1310 can be sealed. Although the sheets 1310 are depicted as having a trapezoidal shape, any shape including round, rectangular, or triangular shapes may be used and is thus not limited thereto.

FIG. 16B shows the overlapped sheets 1310 whose edges 1305 have been sealed to form a contiguous container. The sheets 1310 may optionally include a carrying handle 1315 or other means to facilitate transportation and mobility. Although the embodiment of FIG. 16B is depicted with a carrying handle, other means such as one or more straps, a belt, or a drawstring may be utilized to facilitate transport and mobility and is thus not limited thereto. The edges 1305 may not be sealed around an outlet 1317 if desired. The outlet 1317 may optionally include a spout (not shown) or straw 1320 for accessing filtered water or liquid. To create an inner container 1330, the end of the overlapped sheets 1310 containing the filter holding part 1318 is inverted inside out and placed inside the overlapped sheets 1310, which form an outer container 1340.

FIG. 16C shows an embodiment of a filtration system 1300 comprising an inner container 1330 having a filter holding part 1318 housing a filter (not shown) in which the inner container is nested within an outer container 1340, wherein the inner container 1330 is configured to receive water or liquid to be filtered whereby the water or liquid to be filtered enters the filter at the filter holding part 1318 and, following filtration, exits the filter into the outer container 1340. The outer container 1340 optionally comprises an outlet 1317 wherein the outlet may further comprise a spout (not shown) or a straw 1320 to enable access to filtered water or liquid. The filtration system 1300 may optionally include a carrying handle 1315 or other means to facilitate transport and mobility of the filtration system 1300.

FIG. 16D shows the filtration system 1300 in use, wherein the filtration system includes a carrying handle 1315 to facilitate transport and mobility of the filtration system 1300 and contains unfiltered water 1331 (southwest to northeast lines) within the inner container 1330 and wherein a volume of the unfiltered water 1331 has passed through the filter housed within the filter holding part 1318 and into the outer container 1340 as filtered water 1341 (northwest to southeast lines). The filtration system includes an outlet 1317, wherein the outlet further comprises a straw 1320 to permit access to the filtered water 1341.

FIG. 16E depicts another embodiment of a filtration system 1400 wherein the filtration system 1400 comprises a first container 1405 having an inlet 1406, and an outlet 1420, wherein the outlet comprises a filter holding part 1418 housing a filter (not shown). In some embodiments the first container 1405, except for the inlet 1406, is enclosed, nested in, or contained within a second container 1410 wherein the second container has a spout 1411. In embodiments in which the first container 1405 is enclosed, nested in, or contained within the second container 1410, inlet 1406 protrudes from the filtration system 1400 or is otherwise accessible to the user. In some embodiments, the outlet 1420 can be directly connected to the second container 1410. Although the filtration system 1400 is depicted having a circular shape, any shape including round, rectangular, trapezoidal, or triangular shapes may be used and are thus not limited thereto.

In operation, the first container 1405 is filled with unfiltered water or liquid via the inlet 1406, which is subsequently sealed. Although the unfiltered water will naturally flow through the filter housed in the filter holding part 1418 and out of the outlet 1420 without further action from the user, the rate of filtration can be sped up or increased via application of pressure to the filtration system 1400 wherein the unfiltered water is forced through the filter. The user can apply pressure via sitting, squeezing, resting, resting a heavy object on, or utilizing other physical means on the filtration system. Filtered water is collected and stored in the second container 1410 and can be accessed via the spout 1411. The filtration system 1400 can be manufactured to tolerate a variety of bodyweights. In some embodiments, the filtration system 1400 can withstand bodyweights up to 20 kg, 30 kg, 40 kg, 50 kg, 60 kg, 70 kg, 80 kg, 90 kg, 100, 150 kg, or 200 kg kg without breakage.

FIG. 16F depicts another embodiment of a filtration system 1400F wherein the first container 1405 is directly connected to the second container 1410. Any means may be used to seal the outlet 1420 of the first container 1405 to the second container 1410. In some embodiments, a hose clamp 1415 can be used to seal the outlet 1420 of the first container 1405 to the second container 1410. The hose clamp 1415 may be a worm gear, pinch, or a T-bolt hose clamp or may be a ratchet type hose clip, but is not limited to thereof.

FIG. 16G depicts another embodiment of the embodiment of the filtration system 1400G wherein the first container 1405 is directly connected to the second container 1410 and wherein the first and second containers 1405 and 1410 have a rectangular shape.

FIG. 16H depicts another embodiment of the embodiment of the filtration system 1400H wherein the first container 1405 is directly connected to the second container 1410 and wherein the first and second containers 1405 and 1410 have a circular shape.

FIG. 16I shows another embodiment of a filtration system 1425, which can be integrated into clothing, worn on a body, or mounted to animals. The filtration system 1425 comprises a first container 1426 comprising a filter 1428 wherein the first container 1426 is nested inside of a second container 1431. The first and second containers 1426 and 1431 are small enough to be comfortably worn on the body. In some embodiments, the first and second containers 1426 and 1431 each have a maximum volume of ranging from 500 mL to 2 L. In some embodiments, the second container 1431 may be mounted to clothing, including, but not limited to a jacket 1430, or head gear 1427. In some embodiments, the jacket 1430 can be a raincoat, trench coat, tunic, windbreaker, parka, or anorak, but is not limited thereto. In some embodiments, the head gear 1427 includes, but is not limited to a hat, cap, face mask, balaclava, or a helmet. In some embodiments, the jacket 1430 or the head gear 1427 can include an outlet 1429 directly connected from the second container 1431 by which filtered water or liquid can be accessed by the user. The filtration system 1425, in some embodiments, can also include a handle 1424 or other means for facilitating transport and mobility of the filtration system 1425.

FIG. 16J depicts another embodiment of filtration system 1425J mounted onto an animal.

The dimensions of the containers in the filtration system 1425 may range between 10 cm to 100 cm in length or more, and their width may range between 1 cm or less to 50 cm or more. The containers in the filtration system 1425 may have a volume of less than 1 L, 500 mL, 300 mL, 200 mL, 100 mL, or 50 mL.

FIGS. 17A-17K depict various embodiments of the filter holding part.

FIG. 17A shows an embodiment of a filtration system 1475 comprising a container 1476 having a filter holding part 1478 comprising a hole housing a filter 1470, wherein the filter 1470 has an area larger than the hole and wherein the filter 1470 is mounted to the filter holding part 1478 via a surface of the filter 1470.

FIG. 17B depicts a filter holding part 1485B having a hole 1486 having an area smaller than that of a filter 1480, wherein the filter is mounted to the filter holding part 1485B via sealing a surface of the filter 1480 against the hole 1481.

Any means can be used to form the seal between the filter and the filter holding part or the filter holding part to the filtration system as long as the seal is impervious to water or other liquids. Sealing techniques include, but are not limited to heat sealing, a zipper, a magnet, screw threads, hose clamps, or silicone or closed-cell foam added on a circumferential surface of the filter. When the filter is heat-sealed to the filter holding part, the heat sealing temperature ranges from about 150 to 230° C., 160 to 220° C., 170 to 210° C., 180 to 200° C., or 190 to 195° C. The heat sealing temperature can be held and maintained between 1 and 10 seconds, more specifically, between 2 and 9, 3 and 8, 4 and 7, 5 and 6 seconds. Any heat source may be used for heat sealing as long as the material of the filter holding material and the filter tolerates the heat source such that the material does not burn or degrade and may include a heat sealer, heat gun, torch, candle, or match.

FIG. 17C depicts one embodiment of a filter holding part 1485C comprising a zipper attachment 1520, wherein a filter 1530, encircled by zipper teeth 1510, can be inserted into the zipper attachment 1520 and sealed to the filter holding part 1485C via zipping the zipper.

FIG. 17D shows another embodiment of the filter holding part 1485D having screw threads 1526, wherein the filter 1530, encircled by screw threads 1525, can be screwed into the screw threads 1526, thus sealing the filter 1530 to the filter holding part 1485D. The screw threads 1525 can be carved or machined into the filter 1530 or separately attached to the filter 1530 by an adhesive.

FIG. 17E shows another embodiment of the filter holding part 1485E wherein the filter 1530 can be sealed to the filter holding part via a hose clamp 1540. The clamp may be an embedded string, an elastic band or other mechanism to tighten the holder.

FIG. 17F shows another embodiment of the filter holding part 1485F, wherein the filter holding part is configured to accept a flange 1560 housing the filter 1530, wherein the filter 1530 has a sealant 1562, which can be silicone or closed-cell foam added on a circumferential surface of the filter 1530 to seal the filter 1530 to the flange 1560. Although the filter 1530 is depicted as being sealed to filter via silicone or closed-cell foam, any means as discussed previously may be used to seal the filter 1530 to the flange 1560 as long as the seal is impervious to water. Sealing techniques include, but are not limited to heat sealing, a zipper, a magnet, screw threads, or hose clamps.

FIG. 17G shows another embodiment of the filter holding part 1485G wherein the filter 1530 can be sealed to the filter holding part via a hose clamp 1540. The clamp may be an embedded string, an elastic band or other mechanism to tighten the holder.

FIG. 17H depicts another embodiment of a filter holding part 1575, wherein the filter holding part 1575 comprises a flange 1580 having an end 1590, wherein the flange 1580 comprises a hollow channel 1595 housing a filter 1530, wherein the flange 1580 comprises a base 1585 located opposite the end 1590, wherein the base extends radially from the flange 1580. In some embodiments, the hollow channel 1595 has a uniform diameter penetrating the flange 1580 and the hollow channel may contain one or more filters in series. In some embodiments, the hollow channel 1595 has a variable diameter wherein the diameter can taper or widen as it penetrates the flange (step-tapered structure). The flange 1580 may have an outer diameter ranging between 10 mm and 300 mm or more and the hollow channel has an inner diameter ranging between 10 mm and 300 mm.

In some embodiments, the filter 1530 can be inscribed within the inner diameter of the hollow channel 1595 and lie flush with the end 1590 of the flange 1565. In some embodiments in which the inner diameter of the hollow channel is variable and not uniform, the filter 1530 can be located anywhere within the length of the hollow channel 1595 in which the circumference of the filter 1530 is inscribed within the inner diameter of the hollow channel 1595. In some embodiments, in which the inner diameter of the hollow channel is variable and not uniform, the filter holding part 1575 can comprise one or more additional filters 1530A of different sizes such that the filters 1530 and 1530A are in series. In some embodiments, the inner diameter of the hollow channel 1595 comprises at least two layers in depth, each layer having a sloped circumferential wall so as to be smaller in diameter towards the base 1585 (step-tapered structure).

The hollow channel may have any length, width, height, or diameter. In embodiments in which the hollow channel is cylindrical, the diameter may range from 1 cm to 30 cm. The diameter of the hollow channel may be same throughout the length of the hollow channel or may vary in embodiments in which the hollow channel comprises two or more layers in depth. In such embodiments, the diameter of the hollow channel can be the same or vary at each layer and range from 1 cm to 30 cm. Each of the layers can have a height between 1 cm and 30 cm. In one example, the hollow channel comprises three layers wherein the separate layers have diameters of 3 cm, 2 cm, and 1 cm wherein each layer is 1 cm in height. Although the hollow channel is described cylindrically, it should be understood that the hollow channel can have other shapes such as prismatic, conic, or pyramidal.

FIG. 17I is a cross section of a filter holding part 15751 wherein the inner diameter of the hollow channel 1595 tapers towards the base 1585 and wherein the filter holding part 15751 comprises a filter 1530 and an additional filter 1530A. The diameter of an outer wall of the flange 1580 tapers towards the base 1585. Tapering of the diameter of the outer wall of the flange allows for less material to be used during manufacture and renders the filter holding part correspondingly lighter.

FIG. 17J is a cross section of the filter holding part 1575 depicted in FIG. 17H wherein the inner diameter of the hollow channel 1595 tapers towards the base 1585 and wherein the filter holding part 1575 comprises a filter 1530 and an additional filter 1530A. The diameter of an outer wall of the flange 1580 remains constant throughout the structure of the flange 1580.

A separate insert can house the filter, wherein the insert can be inserted into a filter holding part configured to accept the insert. The insert may include a hollow channel configured to accept the filter wherein the hollow channel can have a uniform diameter or may comprise two or more layers, wherein each layer comprises sloped circumferential wall so as to be smaller in diameter towards the bottom.

The insert may be made of silicone, latex or any other rubber, but is not limited thereto. The insert can be casted, cured, polymerized, or otherwise solidified from utilizing a mold. In some embodiments, the insert can be made via injecting liquid latex rubber into a mold and allowed to stand and solidify at room temperature for about 24 hours before the mold is removed. It should be understood that the insert can be formed utilizing other techniques and is not limited thereto.

The outer walls of the insert may have any length, width, height, or diameter. In embodiments in which the insert is cylindrical, the insert can have an outer wall diameter ranging from 1 cm to 30 cm. The hollow channel housing the filter have any length, width, height, or diameter. Typically, the hollow channel is inscribed within the insert. In an embodiment in which the insert is cylindrical having a hollow channel comprising three layers, the outer wall diameter of the insert can be 5 cm and the separate layers of the hollow channel have diameters of 3 cm, 2 cm, and 1 cm wherein each layer is 1 cm in height. The filter can be housed in any part of the hollow channel or in any layer of the hollow channel and the hollow channel may container one or more housed filters. Although the insert is described cylindrically, it should be understood that the insert can have other shapes such as prismatic, conic, or pyramidal.

FIG. 17K depicts a perspective view of the filter holding part 1575 of FIG. 17J having the shape of a flange (base of flange not shown) and wherein the outer wall of the flange has a uniform diameter. The hollow channel 1595 has a step-tapered structure, which houses a first filter 1530 and an additional filter 1530A.

FIGS. 18A-18J illustrate a process for manufacturing an insert 1550 containing the hollow channel 1595 that can house one or more filters, which can be shaped via 3D printing, casting mold, carving, forging, curing liquid rubber such as silicone or latex, or any combination of these methods. The insert may be separately inserted into a filter holding part to facilitate switching of filters or combinations of filters. As with the filter holding parts of FIGS. 17H-K, the hollow channel can have a uniform diameter or a variable diameter such as a step-tapered structure.

FIGS. 18A and 18B depict various step-tapered structures of the hollow channel 1595 comprising three layers in depth, each layer having a sloped circumferential wall so as to be smaller in diameter towards the bottom.

FIG. 18C shows a mold 1597 for casting the insert 1550 wherein the insert 1550 comprises the hollow channel 1595. The mold 1597 can also include a duct 1596, which is aligned with the bottom of the hollow channel 1595 to ensure that orientation of the hollow channel is straight.

FIG. 18D shows the mold 1597 filled with the casting material 1598 (southwest to northeast lines), which can be silicone, latex or any other rubber, but is not limited thereto. Following filling the mold 1597 with the casting material, the material can be cured, polymerized, or otherwise set and solidified to form the insert 1550.

FIG. 18E shows opening of the mold 1597 following the curing, polymerization, and solidification of the casting material 1598 (southwest to northeast lines). The duct 1596 is also cut and removed from the bottom of the hollow channel such that the hollow channel is open on both ends.

FIG. 18F shows the insert 1550 following casting wherein the insert has the hollow channel 1595.

FIG. 18G is another example of an insert 1550G wherein the mold 1597 can be lifted out from the insert 1550G following curing, solidifying, or polymerizing of the insert.

The casting techniques used to make the insert are not limited to solely forming the insert and can be applied to forming the filter holding part such as when the filter holding part comprises a flange, which may comprise the hollow channel.

FIG. 18H shows an example of casting a flange 1580H with the casting material (southwest to northeast lines) comprising the hollow channel 1595.

FIG. 18I shows a cross section of an insert 15501 having the hollow channel 1595 in which the filter 1530 is housed. Any number of filters of any size may be housed within the hollow channel. Although the filter is depicted as being housed in the middle of the hollow channel, it should be understood that the filter can be housed anywhere within the hollow channel and is not limited thereto.

FIG. 18J shows a cross section of an insert 1550J housing the filter 1530, wherein the insert 1550J has been inserted into a filter holding part 1575. Although the insert is depicted as being inserted in the middle of a cylindrical filter holding part, it should be understood that the shape and positioning of the insert can vary depending upon the applicable application and implementation.

The filter holding part may take the form of a bottle cap, a tube, or a connector.

A bottle cap with an insert housing a filter can be used to filter contaminated water. The filter can be formed to have a diameter ranging from 1 to 20 cm, more specifically, 2 to 15, 3 to 12, 4 to 10, 5 to 9, 5.5 to 8, 6 to 7, or 4.5 cm, in accordance to a design of the filtration system. The height of the filter can be 0.5, 0.75, 1, 1.25, 1.5, 1.75, 2, 2.25, 2.5 cm, 5 cm, 8 cm, 10 cm, 15 cm, 20 cm, 25 cm, or 30 cm. The filter can have the shape of a cylinder, cone, or a cube.

The cap can have a diameter ranging from 1 to 20 cm, more specifically, 2 to 15, 3 to 12, 4 to 10, 5 to 9, 5.5 to 8, 6 to 7, or 4.5 cm, in accordance to a design of the filtration system. In some embodiments, the cap diameter is matched to standard bottle mouth sizes and thread types. The cap can have a thickness of 0.5, 0.6, 0.7, 0.75, 0.8, 0.9, 1, 1.1, 1.2, 1.25, 1.3, 1.4, 1.5, 1.6, 1.7, 1.8, 1.9, 2, 2.5, 3, 3.5, 4, 4.5, 5, 6, 7, 8, 9, 10, 11, 12, 13, 14, 15 mm, or more. The cap can also have threads to connect to other containers. The threads may be of any bottle cap. The threads may be 13-415, 13-425, 15-415, 18-410, 28-400, 28-410, 43-485, or 44-400 in size. Although these are merely a few examples of bottle cap thread sizes, it should be understood that other thread sizes may be used depending upon the applicable application and implementation.

The insert may be made of silicone, latex or any other rubber, which fills a part of inside of the cap. An outer wall of the cap may be made by 3D-printing, injection molding, casting, carving, forging or any shaping of plastic, metal, wood, plant, or glass. The outer wall may be made with: screws for a container for unfiltered water at a top; an air tube to be inserted into the container for unfiltered water and to be in communication with outside of the cap; a holed plate with a cylinder at a bottom to hold the insert inside the cap and to introduce filtered water through the cylinder to an inside of the container of the filtered water; and an air hole in communication with outside of the cap and the inside of the container of the filtered water. Additional adhesive material, caulking material, a clamp or any support for the sealing may also be used.

FIG. 18K shows one embodiment of a filter holding part 1600 having the form of a bottle cap. The filter holding part 1600 comprises a lid 1615 having an inlet 1610 wherein the lid 1615 attaches to a body 1640 configured to attach to a bottle or other container. In some embodiments the inlet 1610 is configured to attach to tubing, a faucet, a pipe, a funnel, a natural water source, or another container. In some embodiments the body comprises one or more sets of threads 1625, which can be used to attach the filter holding part 1600 to a bottle mouth or other container. The body 1640 comprises a chamber 1641, which houses a filter 1630 (not shown), wherein the filter 1630 can be optionally contained within an insert 1550 (not shown). The body 1640 further comprises a plate having a bottom hole 1650 through which filtered water or liquid can flow following filtration through the filter 1630. The body may be plastic, metal, wood, plant, or glass, and may include screws. The filter 1630 may be sealed to the filter holding part 1600 by any means, which include but are not limited to heat sealing, gasket or O-ring, magnet, or silicone or closed-cell foam added on a circumferential surface of the filter 1630. In some embodiments, water enters the filter holding part 1600 through the inlet 1610 to pass through the filter 1630. In some embodiments, water exits the filter holding part 1600 via the inlet 1610 following passage through the filter 1630. In some embodiments, the body and lid are a single part that attach to a mouth of a bottle via threads or other mechanisms, wherein a filter or insert housing the filter is pressed between a surface of the bottle and a surface of the cap, with or without the use of gaskets to form a seal such that water introduced into the cap via inlet 1610 must pass through the filter and into the bottle, or, alternatively, water from the bottle must pass through the filter and the inlet.

FIG. 18L shows an embodiment of the filter holding part 1600L. The filter holding part 1600 is in the form of a bottle cap having a body 1640 and attached via threads 1625 to a bottle 1620. The filter holding part 1600 includes a lid 1615 having an inlet 1610, wherein the inlet 1610 is connected to tubing 1605. The inlet 1610 can have a diameter ranging from 0.2 cm to 2 cm or more. The lid 1615 can have a diameter ranging from 2 cm to 12 cm and a height ranging from 0.5 cm to 2 cm or more. The tubing 1605 can be connected to any source that may supply water or liquid for filtration such as another container, a faucet, a funnel, a pipe, or a natural water source. The body 1640 houses the filter 1630 within a chamber 1641, wherein the filter 1630 can be optionally contained within an insert 1550 and further includes the plate having the bottom hole 1650 to permit filtrate to flow out of the filter holding part 1600. The chamber 1641 may comprise one or more layers in depth. Each layer may have a circumferential wall that can be concave, convex, straight, or any combination and wherein the circumferential wall of each layer can be smaller or larger in diameter towards the plate having the bottom hole 1650. The body 1640 can have a diameter ranging from 2 cm to 30 cm and a height ranging from 2 cm to 20 cm. In some embodiments, the height is 2 cm, 5 cm, 7.5 cm, 10 cm, 15 cm, 20 cm, 25 cm, or 30 cm. In some embodiments, the diameter is 2 cm, 5 cm, 7.5 cm, 10 cm, 15 cm, or 20 cm.

FIGS. 19A-19J depict various embodiments of the filter holding part 1600 in use and attached to various sources of water or other liquids. The filter holding part reported by Ramchander et al. is shown here for illustrative purposes (Ramchander, K., Hegde, M., Antony, A. P., Wang, L., Leith, K., Smith, A., & Karnik, R. (2021)).

FIGS. 19A and 19D show exploded views of the filter holding part 1600 of FIG. 18K comprising a body, a filter, a lid that attaches to the body and seals the filter in place wherein the lid has an opening that can serve as an inlet for the feed water or an outlet for the filtered water. One or more gaskets may be used to form the seal between the filter and the lid.

FIG. 19B shows the filter holding part 1600 whose inlet 1610 is connected to a funnel 1601 to facilitate reception of a feed of water or liquid for filtration.

FIG. 19C shows the filter holding part 1600 whose inlet 1610 is connected to a bag 1602. The bag 1602 may contain the contaminated water or liquid for filtration, which enters the filter holding part 1600 via the inlet 1610. Alternatively, the filter holding part 1600 may be connected or attached to a bottle mouth containing the contaminated water or liquid for filtration, wherein filtered water or liquid exits the filter holding part 1600 via the inlet 1610 and is collected in the bag 1602.

FIG. 19E shows the filter holding part 1600 whose inlet 1610 is connected to a first container 1603 and wherein the body 1640 is attached to a second container 1604. The lid 1615 may be attached to the body 1640 to form a seal and effect the filtration process.

FIG. 19F shows the filter holding part 1600 whose inlet 1610 is connected to a funnel 1601 and wherein the body 1640 is attached to a container 1604. The lid 1615 may be attached to the body 1640 to form a seal and effect the filtration process when water or liquid is decanted from a separate container 1603 into the funnel 1601.

FIG. 19G shows the filter holding part 1600 whose inlet 1610 is connected via tubing 1605 to a first bag 1606 and wherein the body 1640 is connected to a second bag 1607. The lid 1615 may be attached to the body 1640 to form a seal and effect the filtration process.

FIG. 19H shows the filter holding part 1600 whose inlet 1610 is connected via tubing 1605 to the bag 1606 and wherein the body 1640 is connected to a rigid container 1608. The lid 1615 may be attached to the body 1640 to form a seal and effect the filtration process.

FIG. 19I shows another embodiment of the filter holding part 1600 whose connecting means include bottle caps 1609 such that the filter holding part 1600 is configured to fit a specific bottle thread. The bottle caps 1609 each have a hole such that unfiltered water or liquid can pass from the first container 1603 through the filter holding part 1600 housing the filter into the second container 1604 as filtrate.

FIG. 19I shows another embodiment of a filter holding part 16001 whose connecting means include threads such that the filter holding part 16001 is configured to fit a specific bottle thread. The bottle caps 1609 each have a hole such that unfiltered water or liquid can pass from the first container 1603 through the filter holding part 1600 housing the filter into the second container 1604 as filtrate.

FIG. 19K shows an exploded view of an embodiment of a filter holding part 1600K comprising a lid 1615 having an inlet 1610 wherein the lid 1615 attaches to a body 1640 configured to attach to a bottle or other container. In some embodiments the inlet 1610 is configured to attach to tubing, a faucet, a pipe, a funnel, a natural water source, or another container. In some embodiments the body comprises one or more sets of threads 1625, which can be used to attach the filter holding part 1600K to a bottle or other container. The body 1640 comprises a chamber 1641, which houses a filter 1630. The body 1640 further comprises a plate having a bottom hole 1650 through which filtered water or liquid can flow following filtration through the filter 1630. The body may be plastic, metal, wood, plant, or glass, and may include screws. Although the filter 1630 is depicted as being sealed via a gasket 1635, the filter 1630 may be sealed to the filter holding part 1600K by any means, which include but are not limited to heat sealing, gasket or O-ring, magnet, or silicone or closed-cell foam added on a circumferential surface of the filter 1630 and is not limited thereto.

FIG. 19L shows an embodiment of the body 1640 comprising threads 1625 and the plate having the bottom hole 1650.

FIG. 19M shows an embodiment of a filter holding part 1600M. The filter holding part 1600M is in the form of a bottle cap having a body 1640 and attached via threads 1625 to a bottle 1620. The filter holding part 1600M includes a lid 1615 having an inlet 1610, wherein the inlet 1610 is connected to tubing 1605. The inlet 1610 can have a diameter ranging from 0.2 cm to 2 cm. The lid 1615 can have a diameter ranging from 2 cm to 12 cm and a height ranging from 0.5 cm to 2 cm. The tubing 1605 can be connected to any source that may supply water or liquid for filtration such as another container, a faucet, a funnel, a pipe, or a natural water source. The body 1640 houses the filter 1630 within a chamber 1641 and sealed by a gasket 1635 and further includes the plate having the bottom hole 1650 to permit filtrate to flow out of the filter holding part 1600M. The body 1640 can have a diameter ranging from 2 cm to 30 cm and a height ranging from 2 cm to 20 cm. In some embodiments, the height is 2 cm, 5 cm, 7.5 cm, 10 cm, 15 cm, 20 cm, 25 cm, or 30 cm. In some embodiments, the diameter is 2 cm, 5 cm, 7.5 cm, 10 cm, 15 cm, or 20 cm.

FIG. 19N depicts another embodiment of a filter holding part 1700, which is used to connect a first bottle 1710 containing unfiltered water or liquid 1715 to a second bottle 1740, which stores filtered water or liquid 1760. The filter holding part 1700 comprises an elongate body 1770 having a first end and a second end wherein each end has connective means to connect to the first bottle 1710 or the second bottle 1740. A chamber 1718, which houses a filter 1730, is disposed between the first and second ends and the chamber 1718 further comprises a bottom hole 1750 through which filtered water or liquid flows towards the second container 1740. In some embodiments, the chamber may be an insert 1790 having a hollow channel 1795. Connective means may include, but are not limited to screw threads 1725 or male and female connectivity 1780. To regulate and maintain atmospheric pressure within the first and second bottles, the filter holding part 1700 may further include an air duct 1720 that is in communication with the external environment and an air hole 1745 that is in communication with the external environment. The air duct may be a tube, a hose, a nozzle or two sheets forming a hose, with or without a float 1285.

Although examples and their advantages have been described in detail, it should be understood that various changes, substitutions and alterations can be made herein without departing from the spirit and scope of the methods and products formed by the methods, as defined in the appended claims.

The present disclosure will be further illustrated in the following Examples which are given for illustration purposes only and are not intended to limit the disclosure in any way.

### EXAMPLES

### Process of Manufacturing Filter and Subsequent Pre-Treatment

An exemplary filter is made from a piece of gingko sapwood. A piece of gingko sapwood is cut from a gingko tree source. The freshly cut wet piece of gingko sapwood is machined into the filter by cutting a piece of fresh, wet sapwood into a rectangular parallelepiped or a rectangular cuboid using a circular saw. Then, a router is used to machine the slots into the cut piece of wood. The machining is done while keeping the filter wet. The piece of wood is then rinsed thoroughly in water and soaked overnight in 190 or 200 proof ethanol at a volume approximately 5 to 10 times the volume of the piece of wood, and then dried in an oven at 40° C. until there is complete evaporation of the ethanol.

The filter can have a length of 14.2 cm, a width of 9 cm, and a height of 5 cm, and a plurality of slots (7 cm long, 0.2 cm wide, and 4.5 cm deep, and having a 1 cm gaps all around).

The filter can have a length of 11.8 cm, a width of 10 cm, and a height of 5 cm, and a plurality of slots (9 cm long, 0.2 cm wide, and 4.5 cm deep, and having 0.5 cm gaps all around).

After shaping and machining of the wood, the resulting filter is soaked in 3 L of 200 proof ethanol overnight to ensure that the slots are thoroughly rinsed and free of any contaminants. The filter is subsequently dried to remove all traces presence of ethanol. The drying step may be performed at elevated temperatures to accelerate the removal of ethanol from the soaking step.

The described procedure may be applied to all different species of wood and is not limited to gingko sapwood and the procedure is not limited to forming rectangular prismatic shaped filters from the wood. Thus, various shapes of filters such as circular, oval, spherical, conical, or pyramidal may be formed.

### Filtration Device

In an exemplary filtration device, the container in which the filter is to be inserted is made of food-safe materials. Ideally, at least 50% of the materials are post-consumer recycled materials. The outer container must be translucent or transparent polycarbonate to permit visualization of the flow of the liquid to be filtered through the filtration device. The lid and interior components may be opaque.

One setup of an exemplary device comprises a container for receiving the liquid to be filtered that is inserted into a container for collecting the filtered liquid. The container for receiving the liquid to be filtered also comprises a separate removable chamber filled with an adsorbent such as activated carbon sealed to the container via a gasket wherein the filter having a latch mechanism forms a seal with the removable chamber. The filter is pressed into a slot configured to receive the latch mechanism of the filter and the filter is configured to be easily removable through simply pulling the filter out with minimal force to break the gasket seal between the filter and the removable chamber. The removable chamber is similarly configured for easy insertion and removal for replacement of used activated carbon and cleaning.

The filtration device, as set up for operation, involves inserting the container for receiving the liquid to be filtered into the container for collecting the filtered liquid as a filtrate. The containers only need to be separated for convenient storage when not in use and for cleaning. The liquid to be filtered is poured or decanted into the container for receiving the liquid to be filtered. A lid may be used to cover the container for receiving the liquid to be filtered to prevent further contaminants from entering the device. The liquid to be filtered enters the slots on the filter and travels through the tracheid tubes of the filter after which the liquid passes through the removable chamber for further purification and subsequent collection.

The container for receiving the unfiltered water as used in the filtration device can have a height between of 15 and 20 cm and a diameter between 11 and 20 cm. The container for receiving the filtrate or filtered water can have a height of 30 cm and a diameter between 11 and 20 cm such that the container for receiving the unfiltered water can be nested in or stacked on the container for receiving the filtrate.

### Preparation of Test Water for Measuring Removal of Biological Contaminants

An example for removal of biological contaminants is provided following a procedure provided in the publication by Ramchander et. al (Ramchander, K., Hegde, M., Antony, A. P., Wang, L., Leith, K., Smith, A., & Karnik, R. (2021)). The test water used to dose E. coli, MS-2 phage, and rotavirus was prepared by adding the WHO-prescribed dosage of sea salts (Sigma-Aldrich, product number S9883), sodium bicarbonate (BioXtra, 99.5-100.5%, CAS number 144-55-8 procured from Sigma-Aldrich), and tannic acid (ACS reagent grade, CAS number 1401-55-4 obtained from Sigma-Aldrich) or humic acid (50-60%, CAS number 68131-04-4 procured from Alfa Aesar) in DI water.

### Removal of Biological Contaminants

Filters made from gingko wood according to the above example having a 4 cm diameter, 0.375 inch thickness were mounted in 1.5-inch diameter PVC (polyvinyl chloride) tubes (McMaster-Carr, part number 5233K77) and secured in place using hose clamps. Instead of starting with a piece of sapwood, the filters were made by cutting a section of a branch using a circular saw and peeling off the bark. The tubes were connected to a water-filled tank providing a 1.2-m head. E. coli (ATCC 11229) and MS-2 phage (ATCC-15597-B1, with host organism E. coli ATCC-15597) were dosed in the test water at concentrations ≥10⁶ CFU/mL and ≥10⁵ PFU/mL, respectively. In experiments measuring the ability of the filter to remove rotavirus, rotavirus strain SA-11 (ATCC-VR-899) was spiked in the test water at concentration ≥10⁴ PFU/mL. The removal of bacteria and virus was tested at the start of filter operation and when permeance declined to 75, 50, and 25% of the initial value. Flow rates were measured by monitoring the volume of fluid processed by the filters over time. Prior to collecting the filtrate for microbiological analysis, the bottom surface of the xylem filter, the hose clamp, and lower end of the tubing were wiped with cotton soaked in ethanol (while filtration continued). Collection of the filtered sample was started after 10 min to allow sufficient time for any residual ethanol to be flushed or evaporated. E. coli and MS-2 phage were assayed using Standard Method 9222 and 9224 published by American Public Health Association (APHA) for the Examination of Water and Wastewater. The log-reduction values were determined by measuring the bacteria/virus count in the feed solution (C_{feed}), and filtrate (C_{filtrate}) using the following equation:

$$log removal = - {log}_{10} \frac{{C}_{filtrate}}{{C}_{feed}}$$

The peak flow rate and capacity of the gingko filters was observed to exceed 1 L/h and 10 L, respectively.

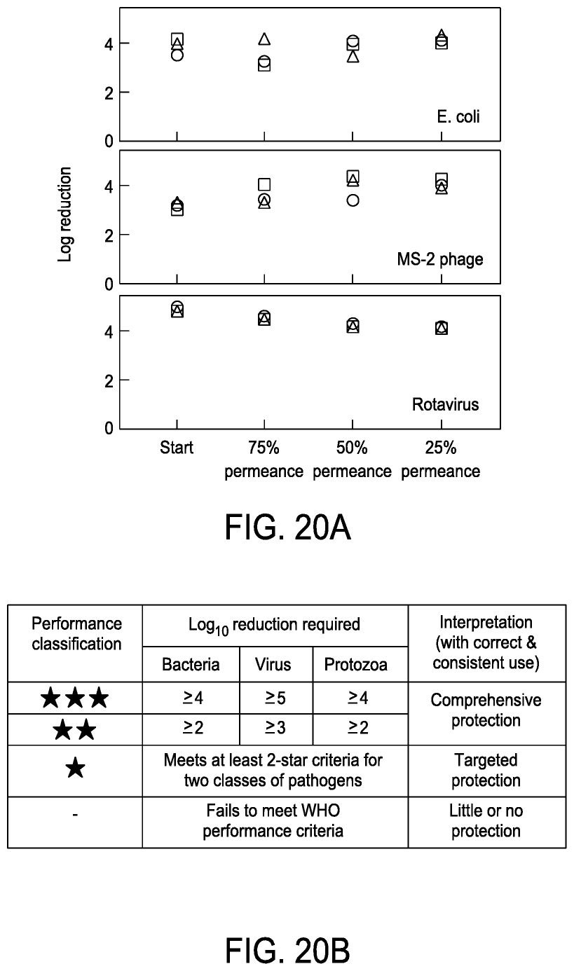

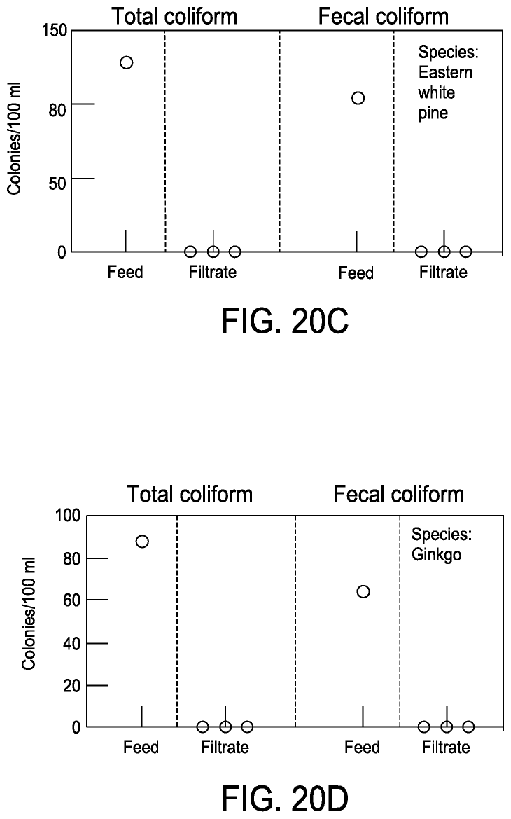

The results are shown in the graph of FIG. 20A, which indicates that the filters showed a greater than >3 log removal of the biological contaminants. Based on the WHO scheme for classification of household water treatment technologies (FIG. 20B), the filters, in removing biological pathogens, provide at least comprehensive protection from bacteria and viruses.

### Removal of Coliform Bacteria

Wood filters made from ginkgo or eastern white pine (1 cm diameter, 0.25 inch thickness) were investigated for their ability to remove coliform bacteria from a natural spring (Kith village, Uttarakhand, India). The filters were operated under 1 m gravity head with the spring water and the level of coliform bacteria in the feed and of the filtrate was measured. (FIGS. 20C and 20D). The data shows that coliform bacteria, including fecal coliform, was not present in the filtrate following filtration of the spring water, demonstrating the feasibility of the present filters to remove biological contaminants.

### Filtration System Utilizing Cinched Flexible Bag and Wood Filter

The side walls of a biodegradable bag having a length of 26 inches, including 6 inches for the length of the handles, and a width of 12 inches are cinched or tapered at the middle of the length (13 inches) of the biodegradable bag and a filter holding part housing a xylem filter constructed from eastern white pine having a diameter of 10 cm and a height of 1 cm is heat sealed inside the tapering point along the circumference of the filter, forming an upper chamber for receiving unfiltered water and a lower chamber for receiving filtered water. The filter works via gravity in which unfiltered water in the upper chamber passes through the filter, which is collected in the lower chamber. The lower chamber can be broken via forming a hole or insertion of a spout, or a straw to permit access to the filtered water.

Alternatively, a biodegradable bag having a length of 26 inches, including 6 inches for the length of the handles, and a width of 12 inches, is cut at its bottom to form a hole, which can radially expand to accommodate the circumference of a xylem filter constructed from eastern white pine having a diameter of 10 cm and a height of 1 cm housed within a filter holding part, wherein the filter holding part is heat sealed to the hole. This permits use of the entire volume of the biodegradable bag for receiving unfiltered water in which an external container must be used for collection and storage of filtered water. The filter works via gravity in which unfiltered water in the filtration system passes through the filter, which exits the filtration system and is collected in the external container.

### Filtration System Utilizing Folded Flexible Sheet

A sheet of plastic is cut into a trapezoidal shaped sheets wherein the trapezoidal sheets have base lengths of 20 cm and 15 cm and leg lengths of 80 cm. Two sheets are overlapped along their perimeters and heat sealed along their perimeters to each other. One sheet is formed with a hole to which the filter holding part is attached, and folded inside-out at approximately middle of the sealed sheet to be in an approximately half height forming an inner container. The filter, constructed from eastern white pine, is mounted in a recess of the filter holding part while stretching the hole of the filter holding part and sealing a circumferential surface of the filter wherein the filter directly interfaces an outer container. Unfiltered water is decanted into the inner container which, via gravity and diffusion, passes through the filter into the outer container as the filtrate.

Alternatively, an elongate sheet 100 cm long and having a maximum width of 17 cm, wherein the width gradually tapers and narrows to 8 cm at both ends of the elongate sheet has a filter or a filter holding part housing a filter formed from eastern white pine having a diameter of 8 cm and a height of 1.5 cm attached and heat sealed to at a hole at each end of the elongate sheet. The elongate sheet is folded in half by overlapping the ends to form a container having a rectangular base 4 cm long and 17 cm wide and wherein the overlapping edges of the elongate sheet are heat sealed. The sealed ends having the filter or filter holding parts are subsequently folded inside out and inserted into the container to form an inner container having the filter or the filter holding parts and an outer container wherein the filter holding part is in communication with the outer container.

### Bottle Cap Filter Holding Part and Use in Filtration System

A filter holding part having the shape of a cylindrical cap is injection molded to have a diameter of 5 cm and a height of 4.5 cm. The bore of the cylinder comprises a plate having a bottom hole wherein the bottom hole has a diameter of 0.8 cm. The plate divides the cylinder into two chambers approximately 3 and 1.5 cm in height. A 5 cm diameter and 3 cm high cylindrical insert having a 3.5 cm diameter and 1 cm high xylem filter made from eastern white pine embedded within the insert is inserted into the 3 cm high chamber. The outside wall of the cap contains threads spaced 0.8 cm apart from each other for connection to external containers. The cap is configured to connect to a lid, wherein the lid has a diameter of 5.6 cm, a height of 1 cm and wherein the lid has an inlet 0.7 cm in diameter.

### Pressure-Actuated Filtration System

Two circular plastic sheets having a diameter of 10 cm are overlapped and heat sealed along their perimeters to each other to form a first container wherein one sheet is formed with a hole to form an outlet for filling of the filtration system and to which the filter holding part comprising the filter can be sealed prior to filtration. Two circular plastic sheets having a diameter of 20 cm are overlapped and heat sealed along their perimeters to each other to form a second container wherein one sheet is formed with a hole to form an inlet that can be removably attached to the outlet of the first container. The xylem filter is formed from eastern white pine having a diameter of 5 cm and a height of 1 cm. Prior to filtration, the filter holding part housing the filter is heat sealed to the outlet and the first container filled with contaminated water. The outlet is subsequently connected to the inlet of the second container. While the contaminated water can flow through the filter for purification and out of the outlet for collection and subsequent use by gravity and without additional force, the filtration rate and the rate of collection of filtered water can be increased by applying pressure to the first container, in particular squeezing with the hands, sitting on the plastic sheets, or resting the user's head against the plastic sheets. The filtered water flows from the filter into the second container for collection and storage.

### Separate Container for Receiving Filtered Water

A plastic sheet 50 cm long and 20 cm wide is folded along its width at 22 cm, 25 cm, and 29 cm into the shape of a W. The sheet is sealed along its width at the two downward facing ridges of the W fold. Subsequently, the corners and the sides of the sheet are sealed, leaving an open top to accept connection to a container housing the filter.

In some aspects, a filter for filtering a liquid, comprises a body having a first surface and defining at least one first opening configured receive a feed of a liquid, a second surface defining at least one second opening configured to dispense the liquid as a filtrate into a container, and a perimeter, wherein the perimeter is configured to form an impenetrable seal with at least one of a third opening defined by the container or an interior of the container via inscription of the perimeter within the opening or the interior of the container. The body comprises wood comprising tracheid tubes oriented in a first direction.

In some aspects, the body comprises a rectangular, circular, spherical, or oval shape.

In some aspects, the liquid is water.

In some aspects, the at least one first opening includes a first plurality of openings. The at least one second opening includes a second plurality of openings.

In some aspects, the first plurality of openings includes a first plurality of slots arranged perpendicular to the first direction. The second plurality of openings includes a second plurality of slots arranged perpendicular to the first direction.

In some aspects, the first plurality of openings includes a first plurality of slots arranged parallel to the first direction, and the second plurality of openings includes a second plurality of slots arranged parallel to the first direction.

In some aspects, the first plurality of openings includes a first plurality of slots disposed at an angle between 0° and 90° relative to the first direction, and the second plurality of openings includes a second plurality of slots disposed at an angled between 0° and 90° relative to the first direction.

In some aspects, each slot of the plurality of slots has a length between about 0.1 mm to about 30 mm.

In some aspects, each slot of the plurality of slots is spaced apart by a width of about 0.1 mm to about 50 mm.

In some aspects, a third plurality of openings disposed between the first plurality of slots and the second plurality of slots.

In some aspects, an adsorbent is disposed in the at least one opening defined by the first surface or the at least one opening slot defined by the second surface.

In some aspects, the adsorbent includes activated carbon.

In some aspects, the adsorbent is disposed in the at least one opening defined by the first surface.

In some aspects, the adsorbent is disposed in the at least one opening defined by the second surface.

In some aspects, the adsorbent is disposed in the at least one opening defined by the first surface and in the at least one opening defined by the second surface.

In some aspects, the wood is chemically modified via acetylation.

In some aspects, the wood is partly or completely carbonized or pyrolyzed.

In some aspects, the wood is chemically modified to bear cyclodextrin functional groups.

In some aspects, the wood is partially chemically modified to enhance stability and resistance against degradation, to enhance filtration, or to improve antimicrobial properties of the filter.

In some aspects, the entirety of the wood is chemically modified to enhance stability and resistance against degradation, to enhance filtration, or to improve antimicrobial properties of the filter.

In some aspects, a latch mechanism connectively couples the filter to a sorbent chamber. The sorbent chamber contains an adsorbent.

In some aspects, the body comprises a single piece of wood.

In some aspects, the wood includes a sapwood.

In some aspects, the sapwood is selected from the group consisting of ginkgo, eastern white pine, spruce, fir, ponderosa pine, and cedar.

In some aspects, the filter provides >3 log reduction of E. coli or rotavirus.

In some aspects, a filter has a volumetric capacity between 8 and 100 L.

In some aspects, a filter has a flow rate between about 1 L/h and 10 L/h. In some aspects, a filter for filtering a fluid includes a body having a first surface and defining at least one first opening configured receive a feed of a liquid, a second surface defining at least one second opening configured to dispense the liquid as a filtrate into a container, and a perimeter. The perimeter is configured to form an impenetrable seal with at least one of a third opening defined by the container or an interior of the container via inscription of the perimeter within the opening or the interior of the container. The body comprises wood comprising tracheid tubes oriented in a first direction, and the fluid comprises a liquid or air.

In some aspects, the fluid comprises a liquid.

In some aspects, the fluid comprises air. In some aspects, a method for filtering a liquid, comprises inserting the filter of aspect 1 into at least one of the opening or the interior of the container thereby forming a continuous, impenetrable seal; decanting the liquid onto the first surface; and collecting the liquid as a filtrate. The contaminated liquid flows through the tracheid tubes from the at least one first opening defined by the first surface and into the at least one second opening defined by the second surface;

In some aspects, the liquid comprises a microbial or chemical contaminant.

In some aspects, the microbial contaminant is E. coli or rotavirus. In some aspects, a filtration system includes an outer container; and an inner container disposed within the outer container. The inner container is configured to receive a liquid to be filtered and including an outlet configured to provide a conduit to the outer container. The outlet includes a filter holding part and a filter is disposed within the filter holding part. The outer container is configured to accept filtered liquid via the conduit.

In some aspects, the filter is inscribed in the filter holding part along the perimeter of the filter.

In some aspects, the filter holding part is made of silicone or latex.

In some aspects, the filter inscribed in the filter holding part further comprises an adsorbent disposed in the at least one opening defined by the first surface or the at least one opening slot defined by the second surface.

In some aspects, the filter inscribed in the filter holding part further comprises an adsorbent disposed in the at least one opening defined by the first surface.

In some aspects, the filter inscribed in the filter holding part further comprises an adsorbent disposed in the at least one opening defined by the second surface.

In some aspects, the filter inscribed in the filter holding part further comprises an adsorbent disposed in the at least one opening defined by the first surface and the at least one opening slot defined by the second surface.

In some aspects, the filter inscribed in the filter holding part is chemically modified via acetylation.

In some aspects, the filter inscribed in the filter holding part is partly or completely carbonized or pyrolyzed.

In some aspects, the filter inscribed in the filter holding part is chemically modified to bear cyclodextrin functional groups.

In some aspects, the filter inscribed in the filter holding part is chemically modified to be functionalized with a fatty acid.

In some aspects, the fatty acid is selected from the group consisting of linoleic acid, oleic acid, and palmitic acid.

In some aspects, wherein the filter has an area greater than an area of the outlet of the inner container, and a surface of the filter is mounted on the outlet and encompasses the area of the outlet.

In some aspects, the filter holding part comprises a cylindrical structure having a recess at an end and a path extending from the recess; the filter is housed within the recess; the recess exposes a surface of the filter; a flange extends radially from an end of the cylindrical structure opposite the recess; and the end of the cylindrical structure comprising the recess extends into the inner container when disposed in the outlet.

In some aspects, a filtration system includes a flexible bag including: a first sheet having a perimeter, an outlet coupled to a surface of the flexible bag, and a filter holding part housing a filter is coupled to the outlet. The perimeter of the first sheet being folded in half and overlaid upon itself and sealed along a folded perimeter.

In some aspects, the filter inscribed in the filter holding part further comprises an adsorbent disposed in the at least one opening defined by the first surface or the at least one opening slot defined by the second surface.

In some aspects, the filter inscribed in the filter holding part further comprises an adsorbent disposed in the at least one opening defined by the first surface.

In some aspects, the filter inscribed in the filter holding part further comprises an adsorbent disposed in the at least one opening defined by the second surface.

In some aspects, the filter inscribed in the filter holding part further comprises an adsorbent disposed in the at least one opening defined by the first surface and the at least one opening slot defined by the second surface.

In some aspects, the filter inscribed in the filter holding part is chemically modified via acetylation.

In some aspects, the filter inscribed in the filter holding part is partly or completely carbonized or pyrolyzed.

In some aspects, the filter inscribed in the filter holding part is chemically modified to bear cyclodextrin functional groups.

In some aspects, the filter inscribed in the filter holding part is chemically modified to be functionalized with a fatty acid.

In some aspects, the fatty acid is selected from the group consisting of linoleic acid, oleic acid, and palmitic acid.

In some aspects, a filtration system includes a flexible bag including a first sheet having a first perimeter, a second sheet having a second perimeter, an outlet disposed on a surface of the flexible bag, and a filter holding part, which is removably coupled to the outlet, houses a filter. The first perimeter of the first sheet is overlaid onto the second perimeter of the second sheet, and each of the first sheet and the second sheet is sealed along the overlaid perimeters; and

In some aspects, a filtration system includes a barrel having a bore extending from a first end to a second end, and a filter holding part disposed inside the bore between the first end of the bore and the second end of the bore. The filter holding part has a recess housing a filter. The filtration system is configured to be removably connected at the first end to a first container and at the second end to a second container.

In some aspects, each of the first end and the second end of the bore comprise threading. The threading enables the barrel to be screwed onto the first container and the second container.

In some aspects, a method of filtering contaminated water utilizing a filtration system includes filling a flexible bag via an outlet with contaminated water; attaching a filter holding part to the outlet thereby forming a seal between the filter holding part and the flexible bag; and applying pressure to the flexible bag.

In some aspects, the step of applying pressure to the flexible bag comprises at least one of squeezing the flexible bag, sitting on the flexible bag, or resting on the flexible bag.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Having thus described in detail various examples and embodiments of the filters, systems, and methods, it is to be understood that the filters, systems, and methods described by the above paragraphs are not to be limited to particular details set forth in the above description as many apparent variations thereof are possible without departing from the spirit or scope of the present invention.

1. A filter for filtering a liquid, comprising:
a body having a first surface and defining at least one first opening configured receive a feed of a liquid, a second surface defining at least one second opening configured to dispense the liquid as a filtrate into a container, and a perimeter, wherein the perimeter is configured to form an impenetrable seal with at least one of a third opening defined by the container or an interior of the container via inscription of the perimeter within the opening or the interior of the container;
wherein the body comprises wood comprising tracheid tubes oriented in a first direction.

2. The filter of claim 1, wherein the body comprises a rectangular, circular, spherical, or oval shape.

3. The filter of claim 3, wherein the liquid is water.

4. The filter of claim 1, wherein the at least one first opening includes a first plurality of openings, and wherein the at least one second opening includes a second plurality of openings.

5. The filter of claim 4, wherein the first plurality of openings includes a first plurality of slots arranged perpendicular to the first direction, and wherein the second plurality of openings includes a second plurality of slots arranged perpendicular to the first direction.

6. The filter of claim 4, wherein the first plurality of openings includes a first plurality of slots arranged parallel to the first direction, and wherein the second plurality of openings includes a second plurality of slots arranged parallel to the first direction.

7. The filter of claim 4, wherein the first plurality of openings includes a first plurality of slots disposed at an angle between 0° and 90° relative to the first direction, and wherein the second plurality of openings includes a second plurality of slots disposed at an angled between 0° and 90° relative to the first direction.

8. The filter of claim 5, wherein each slot of the plurality of slots has a length between about 0.1 mm to about 30 mm.

9. The filter of claim 5, wherein each slot of the plurality of slots is spaced apart by a width of about 0.1 mm to about 50 mm.

10. The filter of claim 5, further comprising a third plurality of openings disposed between the first plurality of slots and the second plurality of slots.

11. The filter of claim 1, further comprising an adsorbent disposed in the at least one opening defined by the first surface or the at least one opening slot defined by the second surface.

12. The filter of claim 11, wherein the adsorbent includes activated carbon.

13-17. (canceled)

18. The filter of claim 1, wherein the wood is chemically modified bear cyclodextrin function groups.

22. (canceled)

23. The filter of claim 1, wherein the wood comprises a sapwood selected from the group consisting of ginkgo, eastern white pine, spruce, fir, ponderosa pine, and cedar.

24. (canceled)

25. The filter of claim 1, wherein the filter provides >3 log reduction of E. coli or rotavirus.

26. The filter of claim 1, having a volumetric capacity between 8 and 100 L.

27. The filter of claim 1, having a flow rate between about 1 L/h and 10 L/h.

28-30. (canceled)

31. A method for filtering a liquid, comprising the steps of:
inserting the filter of claim 1 into at least one of the opening or the interior of the container thereby forming a continuous, impenetrable seal;
decanting the liquid onto the first surface, wherein the contaminated liquid flows through the tracheid tubes from the at least one first opening defined by the first surface and into the at least one second opening defined by the second surface; and
collecting the liquid as a filtrate.

32-33. (canceled)

34. A filtration system comprising:
an outer container; and
an inner container disposed within the outer container, the inner container configured to receive a liquid to be filtered and including an outlet configured to provide a conduit to the outer container, the outlet including a filter holding part; and
the filter of claim 1 disposed within the filter holding part;
wherein via the conduit, the outer container is configured to accept filtered liquid.

35-58. (canceled)

58. A filtration system comprising:
a flexible bag including:
a first sheet having a first perimeter,
a second sheet having a second perimeter,
an outlet disposed on a surface of the flexible bag,
the first perimeter of the first sheet overlaid onto the second perimeter of the second sheet, and
each of the first sheet and the second sheet is sealed along the overlaid perimeters; and
a filter holding part housing the filter of claim 1, wherein the filter holding part is removably coupled to the outlet.

59. A filtration system comprising:
a barrel having a bore extending from a first end to a second end;
a filter holding part disposed inside the bore between the first end of the bore and the second end of the bore, the filter holding part having a recess housing the filter of claim 1;
wherein the filtration system is configured to be removably connected at the first end to a first container and at the second end to a second container.

60-62. (canceled)
